(19) United States
(12) Patent Application Publication
(10) Pub. No.: US 2026/0304582 A1
(43) Pub. Date: Oct. 1, 2026

(54) VOLTAGE CONTROL CIRCUITS AND METHODS OF GRID ELECTRODE STRUCTURES

(71) Applicant: WUHAN UNITED IMAGING HEALTHCARE CO., LTD., Wuhan, Hubei (CN)

(72) Inventors: Yaoqiang DUAN, Wuhan (CN); Da CHEN, Wuhan (CN); Tieshan ZHANG, Shanghai (CN); Xu CHU, Shanghai (CN)

(73) Assignee: WUHAN UNITED IMAGING HEALTHCARE CO., LTD., Wuhan, Hubei (CN)

(21) Appl. No.: 19/517,013

(22) PCT Filed: Dec. 27, 2024
(86) PCT No.: PCT/CN2024/143053

§ 371 Date: Mar. 6, 2026

(30) Foreign Application Priority Data
Dec. 28, 2023 (CN) 202311866932.X

(51) Int. Cl. H05G 1/08; H05G 1/32

(52) U.S. Cl. CPC H05G 1/085; H05G 1/32

(57) ABSTRACT

A voltage control circuit and method of grid electrode structure are provided. The voltage control circuit includes a power amplification circuit, a voltage generation circuit, and a control circuit. The power amplification circuit includes a base control port, a voltage input port, and a voltage output port. The voltage output port is connected with a grid electrode structure within an X-ray tube for providing a target voltage to the grid electrode structure. The voltage generation circuit is connected with the voltage input port of the power amplification circuit for providing an input voltage to the power amplification circuit. The control circuit is connected with the base control port of the power amplification circuit for controlling, according to a voltage control signal, the voltage output port of the power amplification circuit to output the target voltage. The target voltage may be changed to be any value within a preset output range.

### CROSS-REFERENCE TO RELATED APPLICATIONS

This application claims priority to Chinese Patent Application No. 202311866932.X, filed on Dec. 28, 2023, the entire contents of which are hereby incorporated by reference.

### TECHNICAL FIELD

The present disclosure relates to the field of medical device technology, and in particular, to voltage control circuits and methods of grid electrode structures.

### BACKGROUND

An imaging device using X-rays for imaging, such as an electronic computed tomography (CT) device, a digital subtraction angiography (DSA) device, an X-ray machine, etc., may change the voltage of the grid structure in an X-ray tube of the imaging device to control the photon beam current of the imaging device, thus realizing switching the photon beam current, adjusting the current size, adjusting the size of the focal point, adjusting the focal point position, etc.

In current designs, the voltage of the grid electrode structure is switched between two or a finite number of electrical levels, and fast switching of any electrical level within the grid voltage control range is not possible, which leads to limited grid electrode control functions.

Therefore, some embodiments of the present disclosure provide a voltage control circuit of a grid electrode structure and a method for controlling a voltage of the grid electrode structure, to enable fast switching of an arbitrary electrical level within a grid voltage control range.

### SUMMARY

Based on the foregoing, some embodiments of the present disclosure provide a voltage control circuit of a grid electrode structure and a method for controlling a voltage of the grid electrode structure, to enable fast switching of an arbitrary electrical level within a grid voltage control range.

One embodiment of the present disclosure provides a voltage control circuit of a grid electrode structure for controlling a voltage of the grid electrode structure within an X-ray tube. The voltage control circuit may include a power amplification circuit, a voltage generation circuit, and a control circuit. The power amplification circuit includes a base control port, a voltage input port, and a voltage output port. The voltage output port is connected with a grid electrode structure within an X-ray tube for providing a target voltage to the grid electrode structure. The voltage generation circuit is connected with the voltage input port of the power amplification circuit for providing an input voltage to the power amplification circuit. The control circuit is connected with the base control port of the power amplification circuit for controlling, according to a voltage control signal, the voltage output port of the power amplification circuit to output the target voltage. The target voltage may be changed to be any value within a preset output range.

In some embodiments, a voltage value of the voltage generation circuit may be determined according to a voltage requirement range of the grid electrode structure of the X-ray tube.

In some embodiments, the power amplification circuit may operate in a linear region.

In some embodiments, the voltage generation circuit may include a first voltage generation sub circuit and a second voltage generation sub circuit. The first voltage generation sub circuit may be configured to provide a positive voltage to the power amplification circuit, and the second voltage generation sub circuit may be configured to provide a negative voltage to the power amplification circuit.

In some embodiments, the power amplification circuit may include at least one amplification circuit. A base control port of the at least one amplification circuit may be connected with the control circuit, a voltage input port of the at least one amplification circuit may be connected with the voltage generation circuit, and a voltage output port of the at least one amplification circuit may be set as the voltage output port of the power amplification circuit.

In some embodiments, the at least one amplification circuit may include a plurality of amplification circuits. The plurality of amplification circuits may form a multi-stage amplification circuit by connecting a voltage input port of one of the plurality of amplification circuits to a base control port of another amplification circuit of the plurality of amplification circuits. A base control port of a first amplification circuit of the multi-stage amplification circuit may be connected with the control circuit, and a voltage output port of a last amplification circuit may be set to be the voltage output port of the power amplification circuit.

In some embodiments, the at least one amplification circuit may include a plurality of amplification circuits. The plurality of amplification circuits may form a multi-stage amplification circuit by connecting a voltage output port of one of the plurality of amplification circuits to a voltage input port of another amplification circuit of the plurality of amplification circuits. A base control port of the plurality of amplification circuits may be connected with the control circuit, a voltage input port of a first amplification circuit of the multi-stage amplification circuit may be connected with the voltage generation circuit, and a voltage output port of a last amplification circuit may be set to be the voltage output port of the power amplification circuit.

In some embodiments, the power amplification circuit may include a first power amplification sub circuit and a second power amplification sub circuit. A first base control port of the first power amplification sub circuit and a second base control port of the second power amplification sub circuit may be connected with the control circuit. A first voltage input port of the first power amplification sub circuit may be connected with the first voltage generation sub circuit, and a second voltage input port of the second power amplification sub circuit may be connected with the second voltage generation sub circuit. The first voltage output port of the first power amplification sub circuit may be connected with the second voltage output port of the second power amplification sub circuit to form the voltage output port of the power amplification circuit.

In some embodiments, the control circuit may be further configured to provide a bias voltage signal to the first base control port and the second base control port; or a bias voltage circuit may be provided between the power amplification circuit and the control circuit, and the first base control port of the first power amplification sub circuit and the second base control port of the second power amplification sub circuit may be connected with the control circuit via the bias voltage circuit.

In some embodiments, the control circuit may be further configured to control a voltage of the base control port according to a voltage control instruction of the grid electrode structure and control the voltage of the base control port as a preset control voltage after an output voltage of the voltage output port reaches the target voltage.

In some embodiments, the preset control voltage may be a base port control voltage for maintaining the target voltage.

In some embodiments, the voltage control circuit may further include a cathode parameter sampling circuit for sampling an operating parameter of a cathode within the X-ray tube. The control circuit may be further connected with the cathode parameter sampling circuit for adjusting a voltage of the base control port according to the operating parameter.

In some embodiments, the cathode parameter sampling circuit may include at least one of a cathode voltage sampling circuit, a tube current sampling circuit, or a filament current sampling circuit.

In some embodiments, the voltage control circuit may further include a current limiting circuit provided between the voltage output port and the grid electrode structure within the X-ray tube for limiting a current output from the voltage output port.

In some embodiments, the control circuit may include a digital controller. A digital-to-analog converter may be provided between the control circuit and the power amplification circuit, and the digital-to-analog converter may be configured to convert a digital control signal output from the control circuit into an analog control signal to be output to the base control port.

In some embodiments, the control circuit may be further configured to adjust an output voltage of the voltage generation circuit to control the input voltage of the power amplification circuit.

In some embodiments, the voltage control circuit of the grid electrode structure may be integrated within the X-ray tube.

One embodiment of the present disclosure provides a method for controlling a voltage of a grid electrode structure within an X-ray tube. The method may include setting a power amplification circuit to operate in a linear region, wherein the power amplification circuit includes a base control port, a voltage input port, and a voltage output port; and outputting a voltage control signal to the base control port according to a voltage control instruction of the grid electrode structure to control the voltage output port of the power amplification circuit to output a target voltage. The target voltage may be changed to any value within a preset output range, and the preset output range may be determined by a voltage generation circuit connected with the voltage input port.

In some embodiments, the method may further include sampling an operating parameter of a cathode within the X-ray tube; and adjusting a voltage of the base control port according to the operating parameter.

One embodiment of the present disclosure provides an imaging device. The imaging device may include an X-ray tube and the voltage control circuit of the grid electrode structure. The X-ray tube may include the grid electrode structure, a cathode, and an anode, and the voltage control circuit of the grid electrode structure may be connected with the grid electrode structure within the X-ray tube.

In some embodiments, the imaging device may further include a high voltage generator configured to supply a power to the voltage control circuit of the grid electrode structure.

In some embodiments, the high voltage generator may communicate with the control circuit through an optical fiber.

In some embodiments, the imaging device may further include a power supply configured to supply a power to the voltage control circuit of the grid electrode structure.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, and wherein:

FIG. 1 is a schematic diagram illustrating an imaging system according to some embodiments of the present disclosure;

FIG. 2 is a schematic diagram illustrating an exemplary voltage control circuit according to some embodiments of the present disclosure;

FIG. 3 is a schematic diagram illustrating an exemplary voltage control circuit according to some other embodiments of the present disclosure;

FIG. 4 is a schematic diagram illustrating an exemplary voltage control circuit according to some other embodiments of the present disclosure;

FIG. 5 is a schematic diagram illustrating an exemplary voltage control circuit according to some embodiments of the present disclosure;

FIG. 6 is a schematic diagram illustrating an exemplary voltage control circuit according to some other embodiments of the present disclosure;

FIG. 7 is a schematic diagram illustrating an exemplary voltage control circuit according to some other embodiments of the present disclosure;

FIG. 8 is a schematic diagram illustrating an exemplary voltage control circuit of a grid electrode structure according to some embodiments of the present disclosure;

FIG. 9 is a schematic diagram illustrating an exemplary voltage control circuit of a grid electrode structure according to some other embodiments of the present disclosure;

FIG. 10 is a schematic diagram illustrating an exemplary voltage control circuit of a grid electrode structure according to some other embodiments of the present disclosure;

FIG. 11 is a schematic diagram illustrating an exemplary voltage control circuit according to some embodiments of the present disclosure;

FIG. 12 is a schematic diagram illustrating an exemplary voltage control circuit according to some other embodiments of the present disclosure;

FIG. 13 is a schematic diagram illustrating an exemplary voltage control circuit according to some other embodiments of the present disclosure;

FIG. 14 is a schematic diagram illustrating an exemplary voltage control circuit of a grid electrode structure according to some other embodiments of the present disclosure;

FIG. 15 is a schematic diagram illustrating an exemplary voltage control circuit of a grid electrode structure according to some other embodiments of the present disclosure;

FIG. 16 is a schematic diagram illustrating an exemplary voltage control circuit of a grid electrode structure according to some other embodiments of the present disclosure;

FIG. 17 is a flowchart illustrating an exemplary multi-voltage output process according to some embodiments of the present disclosure;

FIG. 18 is a flowchart illustrating an exemplary process for controlling the voltage of a grid electrode structure according to some embodiments of the present disclosure; and

FIG. 19 is a schematic diagram illustrating an exemplary imaging device according to some embodiments of the present disclosure.

### DETAILED DESCRIPTION

To more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that “system”, “device”, “unit” and/or “module” as used herein is a manner used to distinguish different components, elements, parts, sections, or assemblies at different levels. However, if other words serve the same purpose, the words may be replaced by other expressions.

As shown in the present disclosure and claims, the words “one”, “a”, “a kind” and/or “the” are not especially singular but may include the plural unless the context expressly suggests otherwise. In general, the terms “comprise”, “comprises”, “comprising”, “include”, “includes”, and/or “including”, merely prompt to include operations and elements that have been clearly identified, and these operations and elements do not constitute an exclusive listing. The methods or devices may also include other operations or elements.

The flowcharts used in the present disclosure illustrate operations that systems implement according to some embodiments of the present disclosure. It should be understood that the previous or subsequent operations may not be accurately implemented in order. Instead, each step may be processed in reverse order or simultaneously. Meanwhile, other operations may also be added to these processes, or a certain step or several steps may be removed from these processes.

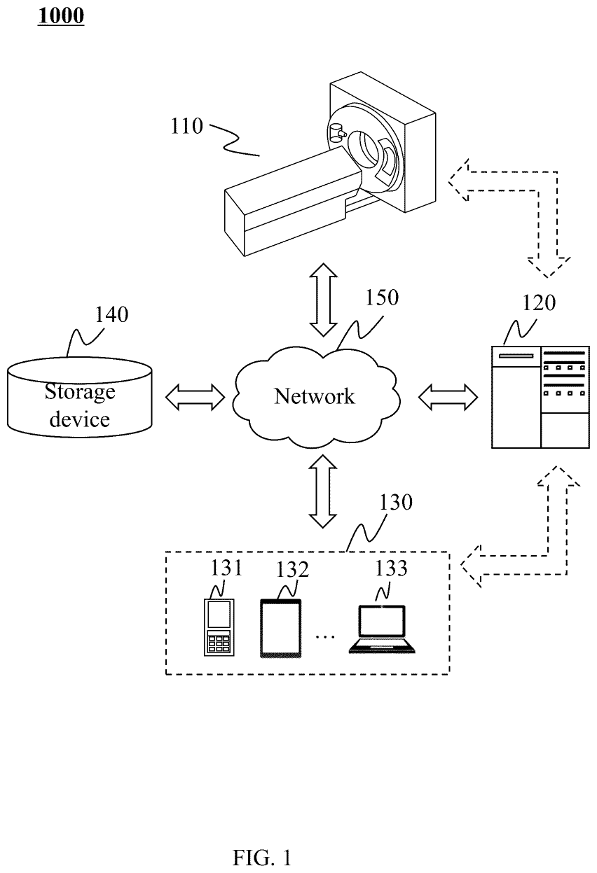

FIG. 1 is a schematic diagram illustrating an imaging system according to some embodiments of the present disclosure.

As shown in FIG. 1, the imaging system 1000 may include an imaging device 110, a processor 120, a terminal device 130, a storage device 140, and a network 150.

In some embodiments, one or more components of the system 1000 may transmit data via the network 150. For example, the processor 120 may obtain information and/or data in the terminal device 130, the imaging device 110, and the storage device 140 via the network 150, or may send information and/or data to the terminal device 130, the imaging device 110, and the storage device 140 via the network 150.

The imaging device 110 refers to a device for controlling radiation rays (e.g., X-rays) for radiologic examination and/or radiotherapy. The imaging device 110 includes but is not limited to, at least one of a medical X-ray treatment apparatus, a medical X-ray diagnostic apparatus, or the like.

In some embodiments, the imaging device 110 may also be applied in other application scenarios. For example, the imaging device 110 also includes an industrial X-ray inspection apparatus for detecting cracks or defects within a material or component, etc., which is not limited in the present disclosure.

In some embodiments, the imaging device may include an X-ray tube, and the X-ray tube includes a grid electrode structure (e.g., a grid electrode structure 510), a cathode, and an anode. The cathode is an electron-emitting source, and the anode is a target material. When the cathode is heated, electrons are emitted, and these electrons are accelerated and hit the anode under an electric field, thus generating X-rays.

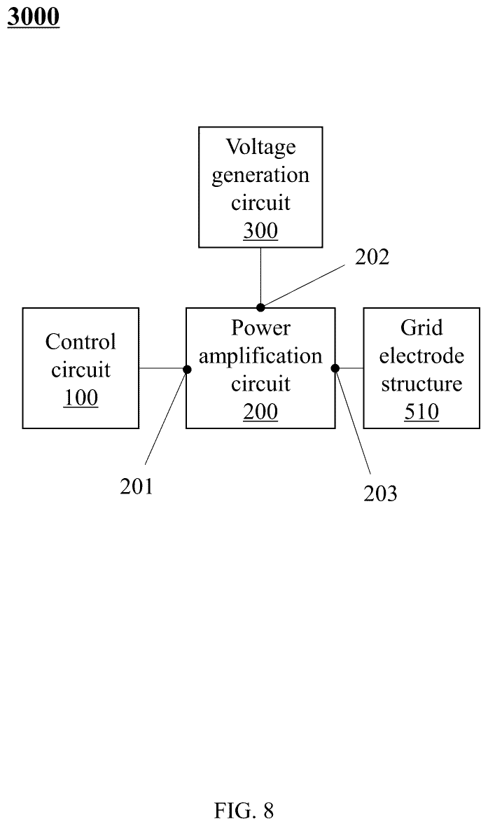

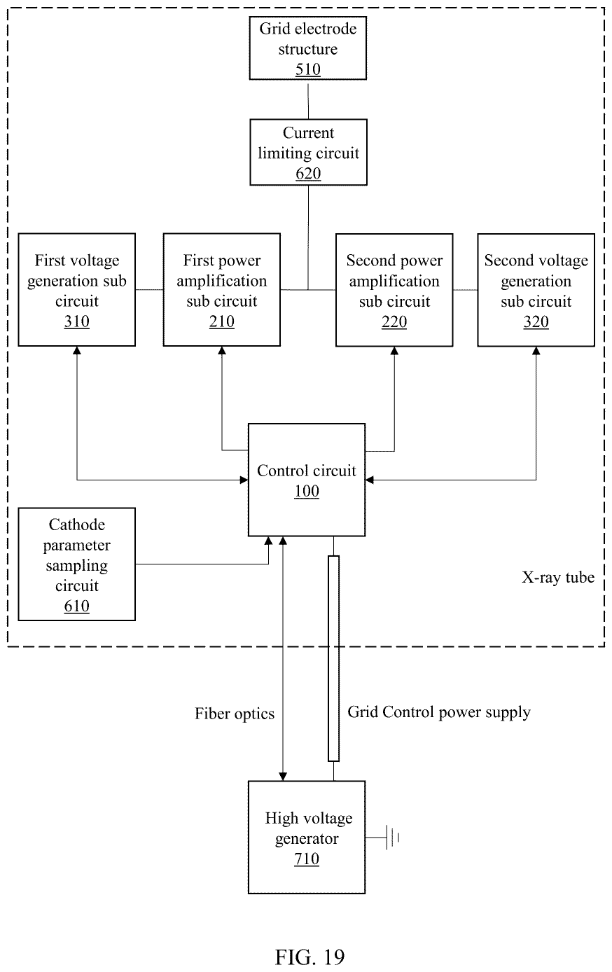

More descriptions regarding the grid electrode structure may be found in FIG. 8 and related descriptions thereof. More descriptions regarding the imaging device 110 may be found in FIG. 19 and related descriptions thereof.

The processor 120 may process data and/or information obtained from other devices in the system 1000. The processor 120 may execute program instructions based on such data, information, and/or processing results to perform at least a portion of the functions described in the present disclosure. In some embodiments, the processor 120 may include one or more sub-processing devices (e.g., a single-core processing device or a multi-core processing device). Merely by way of example, the processor 120 may include a central processing unit (CPU), an application-specific integrated circuit (ASIC), an application-specific instruction processor (ASIP), a graphics processor (GPU), a physical processor (PPU), a digital signal processor (DSP), a microprocessor, etc., or any combination thereof.

The terminal device 130 refers to a device or software used by a user. The terminal device 130 may include a processing unit, a display unit, an input/output unit, a perception unit, a storage unit, or the like.

In some embodiments, the terminal device 130 may be one of a mobile device 131, a tablet computer 132, a laptop computer 133, etc., that has input and/or output capabilities, or any combination thereof. In some embodiments, the terminal device 130 may be used by one or more users, e.g., the user may include a user who directly uses the service or may include other related users.

The storage device 140 may be used to store data and/or instructions. The storage device 140 may include one or more storage components, each of which may be a standalone device or may be part of other devices. In some embodiments, the storage device 140 may include random access memory (RAM), read-only memory (ROM), mass storage, removable memory, volatile read/write memory, etc., or any combination thereof. In some embodiments, the storage device 140 may be implemented on a cloud platform.

The data is a digitized representation of information, which may include a variety of types, such as binary data, text data, image data, video data, or the like. The instruction is a program that may control an apparatus or device to perform a specific function.

The network 150 enables connecting components of the system and/or connecting the system to external resource parts. The network 150 enables communication between components, and with other parts outside of the system, to facilitate the exchange of data and/or information. In some embodiments, the network 150 may be any one or more of a wired network or a wireless network. For example, the network 150 may include a cable network, a fiber optic network, a telecommunications network, the Internet, a local area network (LAN), a wide area network (WAN), a wireless local area network (WLAN), a metropolitan area network (MAN), an in-device bus, in-device wiring, cable connections, or the like or any combination thereof. The network connections between various parts may be made in one of the ways described above or in more than one way. In some embodiments, the network may be in a variety of topologies such as peer-to-peer, shared, centralized, etc., or a combination of topologies.

It should be noted that the above description of the system 1000 is for illustrative purposes only and is not intended to limit the scope of the present disclosure. For a person of ordinary skill in the art, various variations and modifications may be made in accordance with the present disclosure. However, these variations and modifications do not depart from the scope of the present disclosure.

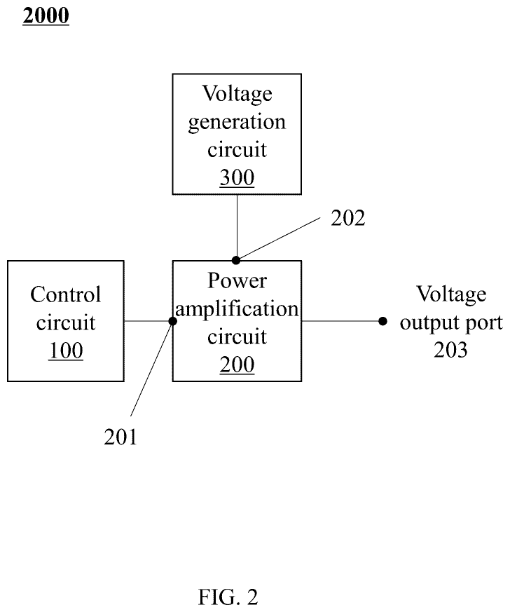

FIG. 2 is a schematic diagram illustrating an exemplary voltage control circuit according to some embodiments of the present disclosure. As shown in FIG. 2, a voltage control circuit 2000 includes a power amplification circuit 200, a voltage generation circuit 300, and a control circuit 100.

The power amplification circuit 200 refers to an electronic circuit for amplifying the power of an input signal. In some embodiments, the power amplification circuit 200 is configured to amplify an input voltage to drive a load (e.g., a grid electrode structure).

In some embodiments, as shown in FIG. 2, the power amplification circuit 200 includes a base control port 201, a voltage input port 202, and a voltage output port 203.

The base control port 201 is connected to the control circuit 100 for receiving a voltage control signal from the control circuit 100.

The voltage input port 202 is connected to the voltage generation circuit 300 for receiving an input voltage from the voltage generation circuit 300.

The voltage output port 203 is configured to output an amplified voltage signal to drive a load (e.g., spiral filament, flat panel filament, etc.). In some embodiments, the voltage output port 203 may be connected to an input port of another circuit (e.g., the grid electrode structure 510, etc.) to pass the output amplified voltage signal to the another circuit, thereby providing an input voltage to the another circuit.

In some embodiments, the power amplification circuit 200 operates in a linear region.

The linear region refers to that the output voltage and input voltage of the power amplification circuit satisfies a preset relationship, and the output voltage of the power amplification circuit may accurately follow the signal change of the input voltage. The preset relationships may include a linear relationship, a quadratic relationship, a cubic relationship, etc.

In some embodiments, the power amplification circuit 200 includes at least one semiconductor device, which includes but is not limited to, a base-controllable semiconductor device such as a transistor, a metal-oxide-semiconductor field-effect transistor (MOSFET), an insulated gate bipolar transistor (IGBT), or the like. By setting the semiconductor device to operate in the linear region, it is possible to make the output voltage of the voltage output port 203 continuously and arbitrarily adjustable within a preset output range by changing the voltage control signal through the control circuit 100 while the input voltage of the voltage input port 202 of the power amplification circuit 200 remains unchanged. In some embodiments, the preset output range may also be referred to as a grid voltage control range.

The voltage generation circuit 300 is configured to provide the input voltage to the power amplification circuit 200.

In some embodiments, the voltage value of the voltage generation circuit 300 is determined according to the voltage requirement range of a component connected with the voltage control circuit 2000. For example, when the voltage control circuit 2000 is configured to control the grid electrode structure of the X-ray tube, the voltage value of the voltage generation circuit 300 may be determined based on the voltage requirement range of the grid electrode structure within the X-ray tube.

In some embodiments, the voltage requirement range of the grid electrode structure may be preset based on practical needs (e.g., a plurality of voltage values that the grid electrode structure needs to switch during imaging, or a range of voltages that the grid electrode structure needs to vary). The voltage value of the voltage generation circuit 300 may be the maximum or minimum value of the voltage requirement range. For example, the voltage requirement range is from −5 kV to 5 kV, and the voltage value of the voltage generation circuit 300 may be −5 kV or 5 kV.

The control circuit 100 may control the voltage output port of the power amplification circuit 200 to output a target voltage based on the voltage control signal.

In some embodiments, the control circuit 100 is a digital controller. The digital controller is a control device based on digital logic and microprocessor technology for receiving an input signal and generating a digital control signal according to a preset program or algorithm.

The voltage control signal is a signal used to indicate the output voltage value of the voltage output port 203 of the power amplification circuit 200. The voltage control signal may be an analog signal or a digital signal, etc., and the specific form of the voltage control signal is determined based on the actual needs, which is not limited in the present disclosure.

In some embodiments of the present disclosure, by controlling the voltage of the base control port of the power amplification circuit and the voltage of the voltage input port of the power amplification circuit 200, the voltage output port of the power amplification circuit may be controlled to output any voltage value within the preset output range as the target voltage, realizing continuous adjustment of the output voltage of the voltage control circuit, without the need to set a plurality of switches for adjusting the output voltage of the voltage control circuit, to achieve arbitrary voltage switching within the preset output range.

In some embodiments, the power amplification circuit 200 includes at least one amplification circuit.

In some embodiments, the base control port of each of the at least one amplification circuit is connected to the control circuit 100, a voltage input port of each of the at least one amplification circuit is connected to the voltage generation circuit 300, and the voltage output port of the at least one amplification circuit is provided as a voltage output port of the power amplification circuit 200.

In some embodiments, the power amplification circuit 200 includes one amplification circuit, and the one amplification circuit being a class A amplification circuit or a class B amplification circuit. The amplification circuit may include a transistor, a MOSFET, an IGBT device, a resistor, etc., or a combination thereof. For example, the amplification circuit may a resistor and at least one of a transistor, a MOSFET, or an IGBT device.

In some embodiments, a user (e.g., a staff) may determine which type of amplification circuit to use based on the actual needs of a load or other circuit back connected to the voltage output port 203. For example, when only positive or negative voltages are required for a load or other circuits (such as the X-ray apparatus, for example, when the rays need to be turned off during fluoroscopy scanning or filming, etc. ,) the amplification circuit may be a class A amplification circuit. When both positive and negative voltages are required for a load or other circuits (e.g., when finer or larger voltages are not required, etc.), the amplification circuit may be a class B amplification circuit.

The class A amplification circuit is a circuit used to realize the characteristics of a class A power amplifier.

The class A power amplifier is a power amplifier that has current conduction throughout the entire cycle of the input signal. The class A power amplifier corresponds to an output signal with low waveform distortion and high amplification but with high current, high heat dissipation, and low efficiency relative to the static operating point.

The class B amplification circuit is a circuit used to realize the characteristics of a class B power amplifier.

The class B power amplifier is a power amplifier that has current conduction during half a cycle of the input signal. The class B power amplifier corresponds to an amplifier that is more efficient but produces crossover distortion at the junction of the positive and negative half cycles of the output signal.

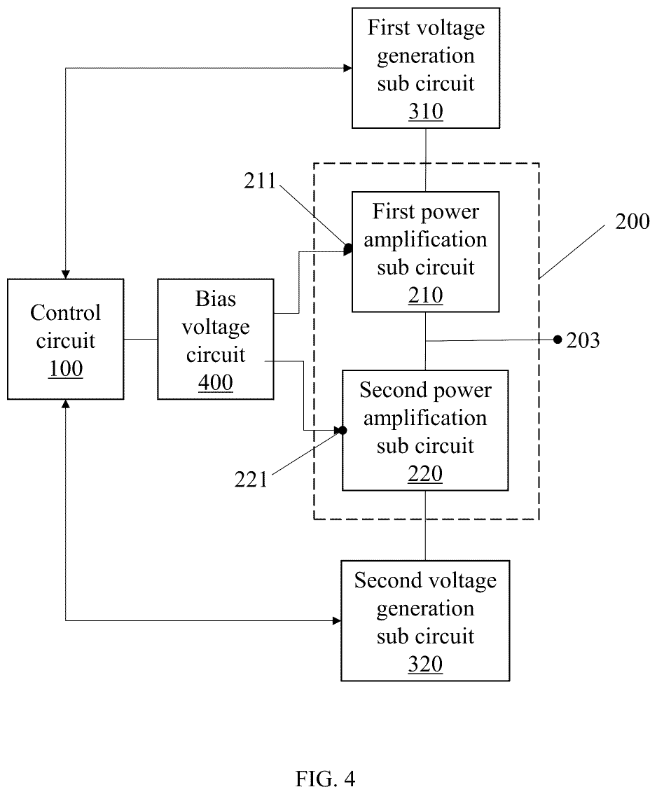

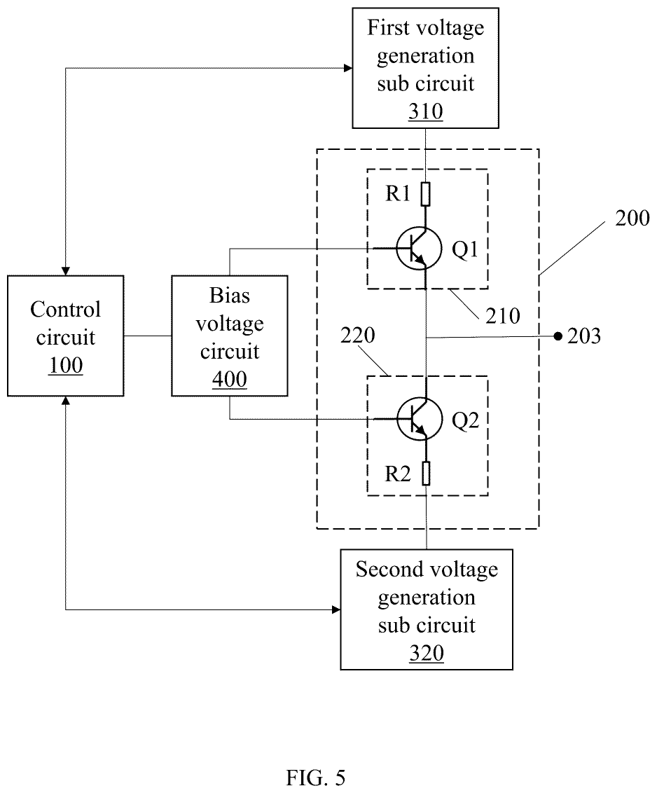

In some embodiments, the amplification circuit is a class AB amplification circuit. More descriptions regarding the amplification circuit and the class AB amplification circuit may be found in FIG. 4, FIG. 5, and the related description thereof.

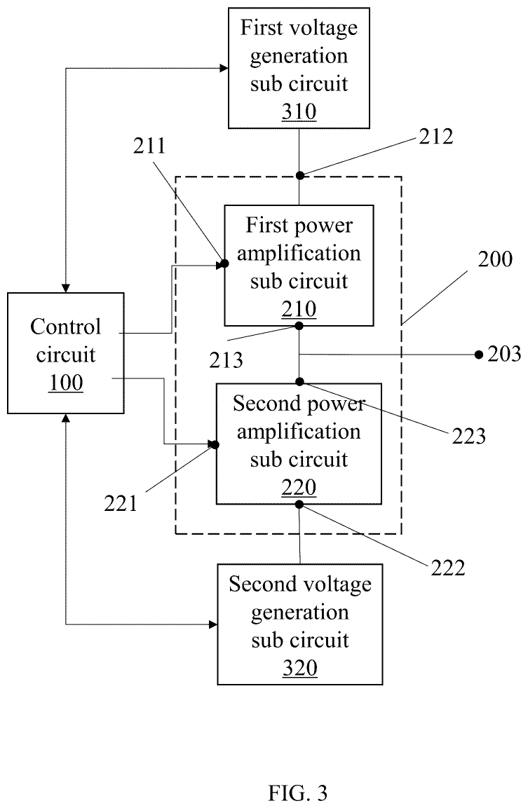

FIG. 3 is a schematic diagram illustrating an exemplary voltage control circuit according to some other embodiments of the present disclosure. As shown in FIG. 3, a voltage control circuit includes a power amplification circuit 200, a voltage generation circuit 300, and a control circuit 100. More descriptions regarding the power amplification circuit 200, the voltage generation circuit 300, and the control circuit 100 may be found elsewhere in the present disclosure (e.g., FIG. 2 and the descriptions thereof).

In some embodiments, as shown in FIG. 3, the voltage generation circuit 300 includes a first voltage generation sub circuit 310 and a second voltage generation sub circuit 320.

The first voltage generation sub circuit 310 and the second voltage generation sub circuit 320 are configured to provide different input voltages of the power amplification circuit 200.

In some embodiments, as shown in FIG. 3, the voltage input port includes a first voltage input port 212 and a second voltage input port 222. The first voltage input port 212 is connected with the first voltage generation sub circuit 310, and the second voltage input port 222 is connected with the second voltage generation sub circuit 320. The other end of the first voltage generation sub circuit 310 and the other end of the second voltage generation sub circuit 320 are connected with the control circuit 100, respectively.

In some embodiments, the first voltage generation sub circuit 310 and the second voltage generation sub circuit 320 have the same polarity. For example, the first voltage generation sub circuit 310 and the second voltage generation sub circuit 320 have both positive polarities. In other words, the first voltage generation sub circuit 310 provides a positive voltage to the first voltage input port 212 and the second voltage generation sub circuit 320 provides a positive voltage to the second voltage input port 222. As another example, the first voltage generation sub circuit 310 and the second voltage generation sub circuit 320 are both negatively polarized. In other words, the first voltage generation sub circuit 310 provides a negative voltage to the first voltage input port 212 and the second voltage generation sub circuit 320 provides a negative voltage to the second voltage input port 222.

In some embodiments, when the first voltage generation sub circuit 310 and the second voltage generation sub circuit 320 are both positively polarized, one of the first voltage generation sub circuit 310 and the second voltage generation sub circuit 320 may be set to provide a positive voltage, the other one of the first voltage generation sub circuit 310 and the second voltage generation sub circuit 320 may be grounded. When the first voltage generation sub circuit 310 and the second voltage generation sub circuit 320 are both of negative polarity, one of the first voltage generation sub circuit 310 and the second voltage generation sub circuit 320 may be set to provide a negative voltage, the other one of the first voltage generation sub circuit 310 and the second voltage generation sub circuit 320 may be grounded.

In some embodiments, the first voltage generation sub circuit 310 and the second voltage generation sub circuit 320 have different polarities. For example, the first voltage generation sub circuit 310 has a positive polarity and the second voltage generation sub circuit 320 has a negative polarity. In other words, the first voltage generation sub circuit 310 provides a positive voltage to the first voltage input port 212, and the second voltage generation sub circuit 320 provides a negative voltage to the second voltage input port 222. As another example, the first voltage generation sub circuit 310 has a negative polarity, and the second voltage generation sub circuit 320 has a positive polarity. In other words, the first voltage generation sub circuit 310 provides a negative voltage to the first voltage input port 212, and the second voltage generation sub circuit 320 provides a positive voltage to the second voltage input port 222.

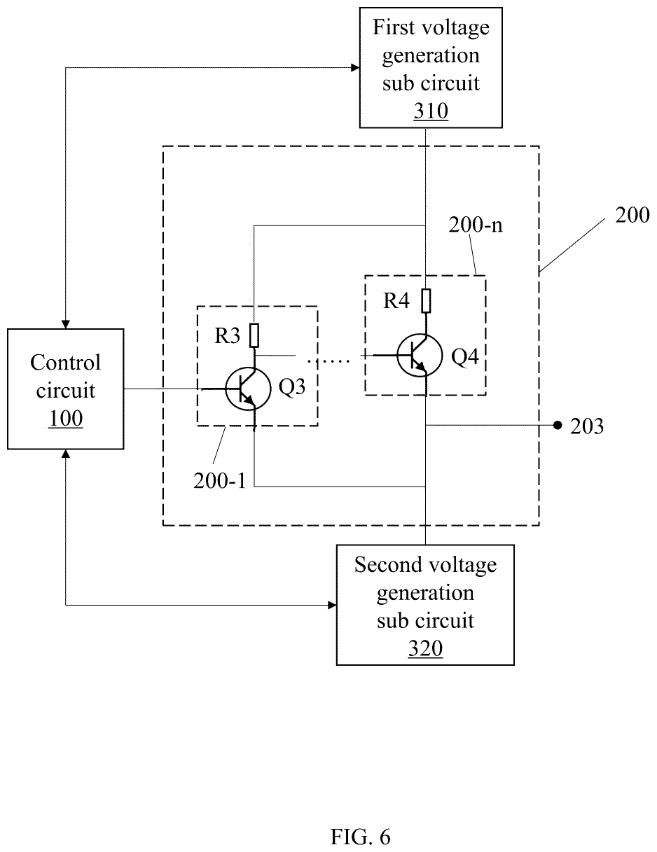

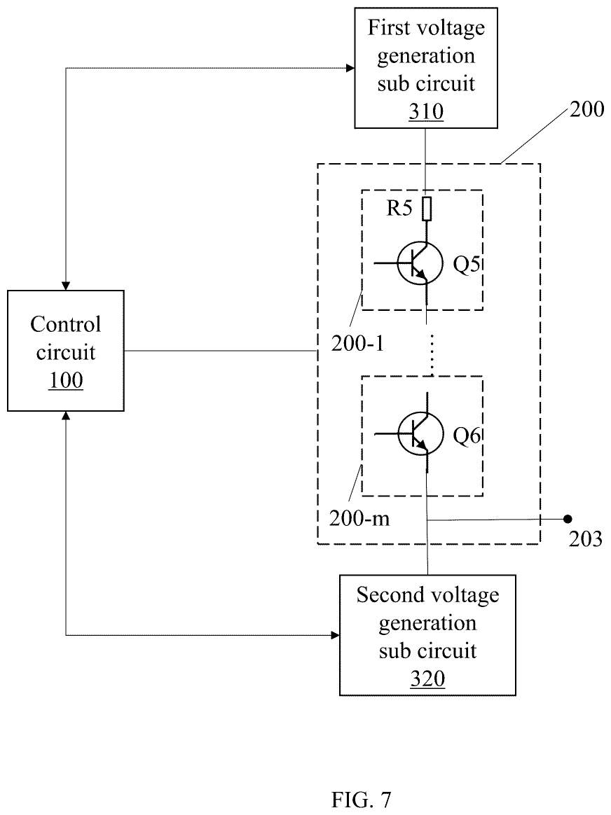

In some embodiments, as shown in FIG. 3, the base control port 201 includes a first base control port 211 and a second base control port 221. The power amplification circuit 200 may include a first power amplification sub circuit 210 and a second power amplification sub circuit 220. One of the first power amplification sub circuit 210 and a second power amplification sub circuit 220 may include one or more amplification circuits connected in cascade or series. More descriptions for the amplification circuits connected in cascade or series may be found elsewhere in the present disclosure (e.g., FIGS. 6 and 7 and the descriptions thereof).

The first base electrode control port 211 and the second base electrode control port 221 are connected to the control circuit 100, respectively. The control circuit 100 controls one of the first power amplification sub circuit 210 and the second power amplification sub circuit 220 to be on and other one of the first power amplification sub circuit 210 and the second power amplification sub circuit 220 to be off using a voltage control signal. For example, when the first power amplification sub circuit 210 is on and the second power amplification sub circuit 220 is off, the output voltage of the voltage output port 203 is continuously and arbitrarily adjustable in a preset output range under the first power amplification sub circuit 210. When the second power amplification sub circuit 220 is on and the first power amplification sub circuit 210 is off, the output voltage of the voltage output port 203 is continuously and arbitrarily adjustable within the preset output range under the second power amplification sub circuit 220. More descriptions regarding the preset output range may be found in FIG. 2. More descriptions regarding the first power amplification sub circuit 210, the second power amplification sub circuit 220, etc. may be found in FIG. 3 and related descriptions hereinafter.

Some embodiments of the present disclosure are capable of providing different voltages separately by using the first voltage generation sub circuit and the second voltage generation sub circuit, enhancing flexibility, further expanding the output voltage range of the voltage control circuit and the application range of the voltage control circuit. By outputting positive and negative voltages respectively through the first voltage generation sub circuit and the second voltage generation sub circuit, the voltage control circuit may be applied in a bipolar operation mode to meet specific circuit requirements.

In some embodiments, as shown in FIG. 3, the power amplification circuit 200 includes a first power amplification sub circuit 210 and a second power amplification sub circuit 220.

The first power amplification sub circuit 210 is configured to amplify the power of the input voltage of the first voltage input port 212. The second power amplification sub circuit 220 is configured to amplify the power of the input voltage of the second voltage input port 222.

In some embodiments, the first base control port 211 of the first power amplification sub circuit 210 and the second base control port 221 of the second power amplification sub circuit 220 are connected with the control circuit 100. The first voltage input port 212 of the first power amplification sub circuit 210 is connected with the first voltage generation sub circuit 310, and the second voltage input port 222 of the second power amplification sub circuit 220 is connected with the second voltage generation sub circuit 320. The first voltage output port 213 of the first power amplification sub circuit 210 and the second voltage output port 223 of the second power amplification sub circuit 220 are connected together to form the voltage output port 203 of the power amplification circuit 200.

The first base control port 211 is a port in the first power amplification sub circuit 210 for receiving a control signal from the control circuit 100.

The second base control port 221 is a port in the second power amplification sub circuit 220 for receiving a control signal from the control circuit 100.

The first voltage input port 212 is a port in the first power amplification sub circuit 210 for receiving an input voltage.

The second voltage input port 222 is a port in the second power amplification sub circuit 220 for receiving an input voltage.

The first voltage output port 213 is a port in the first power amplification sub circuit 210 for outputting a processed voltage signal. The second voltage output port 223 is a port in the second power amplification sub circuit 220 for outputting the processed voltage signal.

In some embodiments, the first power amplification sub circuit 210 and the second power amplification sub circuit 220 may form a class B power amplifier. Specifically, the first power amplification sub circuit 210 may act as an upper bridge arm of the class B power amplifier and the second power amplification sub circuit 220 may act as a lower bridge arm of the class B power amplifier. Alternatively, the first power amplification sub circuit 210 may act as the lower bridge arm of the class B power amplifier, and the second power amplification sub circuit 220 may act as the upper bridge arm of the class B power amplifier. Each of the first power amplification sub circuit 210 and the second power amplification sub circuit 220 may be formed by a transistor, a MOSFET, or an IGBT device, or may be formed by any one of the transistor, the MOSFET, or the IGBT device combined with a resistor.

Some embodiments of the present disclosure, by using the first power amplification sub circuit and the second power amplification sub circuit to amplify the voltage provided by the first voltage generation sub circuit and the second voltage generation sub circuit, respectively, any voltage value within a preset output range may be output, maximizing the control function of the output voltage resolution, and realizing rapid switching of any electrical level within the preset output range.

FIG. 4 is a schematic diagram illustrating an exemplary voltage control circuit according to some other embodiments of the present disclosure. As shown in FIG. 4, a voltage control circuit includes a power amplification circuit 200, a voltage generation circuit 300, and a control circuit 100. More descriptions regarding the power amplification circuit 200, the voltage generation circuit 300, and the control circuit 100 may be found elsewhere in the present disclosure (e.g., FIG. 2, FIG. 3, and the descriptions thereof). For example, as shown in FIG. 4, the power amplification circuit 200 may include the first power amplification sub circuit 210 and the second power amplification sub circuit 220.

The voltage control circuit may also include a bias voltage circuit 400.

In some embodiments, the control circuit 100 is also configured to provide a bias voltage signal to the first base control port 211 and the second base control port 221.

The bias voltage signal is a voltage signal used to set an operating point of the amplification circuit.

In some embodiments, the control circuit 100 maintains the power amplification circuit 200 (e.g., the first power amplification sub circuit 210 and the second power amplification sub circuit 220) at a preset voltage level (also referred to as a bias state) when there is no signal input via the bias voltage signal to ensure that the power amplification circuit 200 can correctly amplify the input signal.

In some embodiments, as shown in FIG. 4, the bias voltage circuit 400 is provided between the power amplification circuit 200 and the control circuit 100.

The bias voltage circuit 400 is a circuit configured to generate and provide the bias voltage signal.

In some embodiments, as shown in FIG. 4, the first base control port 211 of the first power amplification sub circuit 210 and the second base control port 221 of the second power amplification sub circuit 220 are connected, via the bias voltage circuit 400, to the control circuit 100.

FIG. 5 is a schematic diagram illustrating an exemplary voltage control circuit according to some embodiments of the present disclosure. As shown in FIG. 5, a voltage control circuit includes a power amplification circuit 200, a voltage generation circuit 300, a bias voltage circuit 400, and a control circuit 100. More descriptions regarding the power amplification circuit 200, the voltage generation circuit 300, and the control circuit 100 may be found elsewhere in the present disclosure (e.g., FIG. 2, FIG. 3, FIG. 4, and the descriptions thereof). For example, as shown in FIG. 5, the power amplification circuit 200voltage control circuit may include the first power amplification sub circuit 210 and the second power amplification sub circuit 220.

In some embodiments, as shown in FIG. 5, the first power amplification sub circuit 210 in the power amplification circuit 200 includes a first transistor Q1 and a first resistor R1, and the second power amplification sub circuit 220 includes a second transistor Q2 and a second resistor R2. The first end of the first resistor R1 is connected to the first voltage generation sub circuit 310, and the second end of the first resistor R1 is connected to the collector of the first transistor Q1. The base of the first transistor Q1 is connected to the bias voltage circuit 400, and the emitter of the first transistor Q1 is co-connected with the collector of the second transistor Q2 as the voltage output port 203 of the power amplification circuit 200. The emitter of the second transistor Q2 is connected to the first end of the second resistor R2, the second end of the second resistor R2 is connected to the second voltage generation sub circuit 320, and the base of the second transistor Q2 is connected to the bias voltage circuit 400.

In some embodiments, the control circuit 100 may provide a bias voltage signal to the first base control port of the first power amplification sub circuit 210 and the second base control port of the second power amplification sub circuit 220 to form a class AB amplification circuit.

The class AB amplification circuit is a circuit configured to realize the characteristics of a class AB power amplifier.

The class AB power amplifier is a power amplifier in which the current conduction time is greater than half the cycle of the input signal and less than the full cycle of the input signal. The class AB power amplifier combines the advantages of both class A power amplifier and class B power amplifier, thereby having higher efficiency. At the same time, by making the transistor in a micro conductance state in a static state, the crossover distortion may be reduced.

In some embodiments, by providing the bias voltage circuit 400 between the first base control port (e.g., the base end of the first transistor Q1) of the first power amplification sub circuit 210 and the control circuit 100, and between the second base control port (e.g., the base end of the second transistor Q2) of the second power amplification sub circuit 220 and the control circuit 100, controlling the bias voltage circuit 400 provides a bias current to the first base control port of the first power amplification sub circuit 210 and the second base control port of the second power amplification sub circuit 220, and the class AB power amplifier may be formed. The first power amplification sub circuit 210 serves as an upper bridge arm of the class AB power amplifier and the second power amplification sub circuit 220 serves as a lower bridge arm of the class AB power amplifier. Alternatively, the first power amplification sub circuit 210 serves as the lower bridge arm of the class AB power amplifier and the second power amplification sub circuit 220 serves as the upper bridge arm of the class AB power amplifier. Each of the first power amplification sub circuit 210 and the second power amplification sub circuit 220 may be formed by a transistor, a MOSFET, or an IGBT device, or may be formed by any one of the transistor, the MOSFET, or the IGBT device combined with a resistor.

Some embodiments of the present disclosure provide the bias voltage signal through the control circuit or the bias voltage circuit, reducing the waveform distortion of the output signal, enabling the formation of the AB class power amplification circuit, and ensuring the stable operation of the amplification circuit.

In some embodiments, by directly connecting the base of the first transistor Q1 of the first power amplification sub circuit 210 shown in FIG. 5 to the control circuit 100, and directly connecting the base of the second transistor Q2 of the second power amplification sub circuit 220 to the control circuit 100, a class B power amplifier may be formed, i.e., the power amplification circuit 200 is a class B power amplifier.

In some embodiments, at least one of the first power amplification sub circuit 210 and the second power amplification sub circuit 220 may be a multi-stage amplification circuit. For example, each of the first power amplification sub circuit 210 and the second power amplification sub circuit 220 includes a plurality of amplification circuits, and the plurality of amplification circuits form a multi-stage amplification circuit by connecting a voltage output port of one amplification circuit to a voltage input port of another amplification circuit (e.g., the multi-stage amplification circuit formed by connecting in the manner shown in the dashed box 200 of FIG. 7). As another example, each of the first power amplification sub circuit 210 and the second power amplification sub circuit 220include a plurality of amplification circuits, and the plurality of amplification circuits form a multi-stage amplification circuit by connecting a voltage input port of one amplification circuit to a base control port of another amplification circuit (e.g., a multi-stage amplification circuit formed by connecting in the manner shown in the dashed line box 200 of FIG. 6). As yet another example, the first power amplification sub circuit 210 includes a multi-stage amplification circuit formed by connecting a voltage input port of one amplification circuit to a base control port of another amplification circuit, and the second power amplification sub circuit 220 includes a multi-stage amplification circuit formed by connecting a voltage input port of one amplification circuit to a voltage input port of another amplification circuit. As yet another example, at least one of the first power amplification sub circuit 210 and the second power amplification sub circuit 220 may be a multi-stage amplification circuit formed by combining the connection shown in the dashed box 200 of FIG. 6 with the connection shown in the dashed box 200 of FIG. 7 (e.g., a plurality of structures shown in the dashed box 200 of FIG. 6 are connected in series to form the multi-stage amplification circuit).

FIG. 6 is a schematic diagram illustrating an exemplary voltage control circuit according to some embodiments of the present disclosure. As shown in FIG. 6, a voltage control circuit includes a power amplification circuit 200, a voltage generation circuit 300, and a control circuit 100. More descriptions regarding the power amplification circuit 200, the voltage generation circuit 300, and the control circuit 100 may be found elsewhere in the present disclosure (e.g., FIGS. 2-5 and the descriptions thereof). For example, the voltage generation circuit 300 may include a first voltage sub circuit 310 and a second voltage sub circuit 320.

In some embodiments, the power amplification circuit 200 includes a plurality of amplification circuits as shown in FIG. 6, the plurality of amplification circuits being connected in cascade to form a multi-stage amplification circuit.

In some embodiments, the plurality of amplification circuits may form the multi-stage amplification circuit by connecting a voltage input port of one amplification circuit to a base control port of another amplification circuit. As shown in FIG. 6, the plurality of amplification circuits is formed by connecting a voltage input port of a first amplification circuit 200-1 to a base control port of a second amplification circuit (not shown in the figure), and the voltage input port of the second amplification circuit is connected to a base control port of a third amplification circuit (not shown in the figure) until a voltage input port of the n−1st amplification circuit (not shown in the figure) is connected to a base control port of the nth amplification circuit 200-n to form the multi-stage amplification circuit.

In some embodiments, as shown in FIG. 6, the base control port of the first amplification circuit 200-1 in the multi-stage amplification circuit is connected to the control circuit 100, and a voltage output port of the last amplification circuit 200-n is set to be as the voltage output port 203 of the power amplification circuit 200.

In some embodiments, whether the n amplification circuits from the first amplification circuit 200-1 to the last amplification circuit 200-n include a resistor may be preset according to a practical need. For example, at least one of the n amplification circuits includes the resistor. As another example, each of the n amplification circuits includes or does not include a resistor. It should be noted that each of the amplification circuits, which may include a transistor, a MOSFET, an IGBT device, or a transistor and a resistor, are labeled as a group in FIG. 6 for ease of illustration.

In some embodiments, as shown in FIG. 6, a third resistor R3 and a third transistor Q3 form the first amplification circuit 200-1. A fourth resistor R4 and a fourth transistor Q4 form the last amplification circuit 200-n.

In some embodiments, when an amplification circuit includes only a transistor, the base control port, the voltage input port, and the voltage output port of the transistor are the base control port, the voltage input port, and the voltage output port of the amplification circuit, respectively. When the amplification circuit includes a resistor and a transistor/MOSFET, the voltage input port of the amplification circuit is the other end of the resistor (i.e., one end of the resistor is connected to the first voltage sub circuit 310 and the other end is the voltage input port of the single amplification circuit).

In some embodiments, as shown in FIG. 6, the voltage output port of the power amplification circuit 200 formed by the plurality of amplification circuits is connected with the second voltage generation sub circuit 320, and the voltage input port of the power amplification circuit 200 is connected with the first voltage generation sub circuit 310.

In some embodiments, a count (i.e., n) of the amplification circuits between the first amplification circuit 200-1 and the last amplification circuit 200-n is not limited, for example, the count of the amplification circuits may be 1, 3, 6, etc., and a plurality amplification circuits are connected step by step to form the multi-stage amplification circuit for voltage amplification.

The multi-stage amplification circuit is connected in a cascade, and the output voltage of the former amplification circuit is amplified by the latter amplification circuit. For example, the amplification circuit 200-(i+1) in the i+1st stage amplifies the output voltage of the amplification circuit 200-i in the i-th stage, realizing the multi-stage amplification of the output voltage. The output voltage range of the voltage output port is much larger, and the voltage output port may be designated as a voltage source to supply power to the load. The value of i is any one of the values from 1 to n−1.

In some embodiments, by setting a plurality of amplification circuits connected in cascade, the multi-stage amplification circuit for voltage amplification may be formed. The base control port of at least one of the plurality of amplification circuits receives a voltage control signal provided by the control circuit 100 to control the multi-stage amplification circuit to operate in the linear region, and the voltage control signal may be used to determine a voltage magnitude of a target voltage output by the voltage output port of the power amplification circuit 200. The count of amplification circuits in the multi-stage amplification circuit may be used to determine the maximum magnitude of voltage that may be withstood on the power amplification circuit 200.

It should be noted that the power amplification circuit 200 in FIG. 6 is mainly used to illustrate that the plurality of amplification circuits are connected in cascade to form the multi-stage amplification circuit. In some embodiments, the control circuit 100, the power amplification circuit 200, and the first voltage establishment sub circuit 310 form a class A power amplifier. The control circuit 100, the power amplification circuit 200, and the second voltage generation sub circuit 320 do not have an amplifying effect, and the second voltage generation sub circuit 320 may be omitted.

Similarly, in some embodiments, the control circuit 100, the power amplification circuit 200, and the second voltage generation sub circuit 320 form a class A power amplifier. The control circuit 100, the power amplification circuit 200, and the first voltage generation sub circuit 310 do not have an amplifying effect, and the first voltage generation sub circuit 310 may be omitted.

FIG. 7 is a schematic diagram illustrating an exemplary voltage control circuit according to some embodiments of the present disclosure. As shown in FIG. 7, a voltage control circuit includes a power amplification circuit 200, a voltage generation circuit 300, and a control circuit 100. More descriptions regarding the power amplification circuit 200, the voltage generation circuit 300, and the control circuit 100 may be found elsewhere in the present disclosure (e.g., FIGS. 2-5 and the descriptions thereof). For example, the voltage generation circuit 300 may include a first voltage sub circuit 310 and a second voltage sub circuit 320.

In some embodiments, as shown in FIG. 7, the power amplification circuit 200 includes a plurality of amplification circuits, and the plurality of amplification circuits are connected in series to form a multi-stage amplification circuit.

In some embodiments, the plurality of amplification circuits form the multi-stage amplification circuit by connecting a voltage output port 203 of one amplification circuit to a voltage input port of another amplification circuit. As shown in FIG. 7, the plurality of amplification circuits form the multi-stage amplifier circuit by connecting a voltage output port 203 of a first amplification circuit 200-1 to a voltage input port of a second amplification circuit (not shown in the figure), and connecting the voltage output port 203 of the second amplification circuit to a voltage input port of a third amplification circuit (not shown in the figure), until connecting a voltage output port 203 of the m−1st amplification circuit (not shown in the figure) to a voltage input port of the m-th amplification circuit 200-m.

In some embodiments, base control ports of the plurality of amplification circuits are connected with the control circuit 100, a voltage input port of the first amplification circuit in the plurality of amplification circuits is connected with a voltage generation circuit, and a voltage output of the last amplification circuit port is set to be the voltage output port 203 of the amplification circuit.

In some embodiments, as shown in FIG. 7, the base control ports from the amplification circuit 200-1 to the amplification circuit 200-m are connected with the control circuit 100, the voltage input port of the first amplification circuit 200-1 in the multi-stage amplification circuit input port is connected with the first voltage generation sub circuit 310, and the voltage output port 203 of the last amplification circuit 200-m is set to be the voltage output port 203 of the power amplification circuit 200.

In some embodiments, the voltage output port 203 of the power amplification circuit 200 may also be a voltage output port 203 of any one of the amplification circuit 200-1 to the amplification circuit 200-m, which may be set according to the actual needs.

In some embodiments, as shown in FIG. 7, a fifth resistor R5 and a fifth transistor Q5 form the first amplification circuit 200-1. A sixth transistor Q6 forms the last amplification circuit 200-m.

In some embodiments, whether the m amplification circuits from the first amplification circuit 200-1 to the last amplification circuit 200-m include a resistor may be preset according to actual needs.

In some embodiments, when an amplification circuit among the plurality of amplification circuits includes only a transistor, the base control port, the voltage input port, and the voltage output port 203 of the transistor are the base control port, the voltage input port, and the voltage output port 203 of the amplification circuit, respectively. When the amplification circuit includes a resistor and a transistor/MOSFET, the voltage input port of the first amplification circuit is the other end of the resistor (i.e., one end of the resistor is connected with the first voltage generation sub circuit 310 and the other end is the voltage input port of the first amplification circuit).

An amplification circuit between the first amplification circuit 200-1 and the last amplification circuit 200-m includes a transistor. There is no limit to the count of amplification circuits, and the plurality of amplification circuits may be connected in series to form the multi-stage amplification circuit for current amplification.

By connecting the plurality of amplification circuits step by step to form a series circuit and superimposing the output currents of the plurality of amplification circuits step by step, a multi-stage amplification of the output current is realized, and the multi-stage amplification circuit for current amplification is formed, so that the output current range of the voltage output port 203 is larger. The multi-stage amplification circuit for current amplification may be used as a current source to supply power to the load.

In some embodiments, the count (i.e., m) of amplification circuits in the multi-stage amplification circuit connected in series may be used to determine the maximum amount of current that the power amplification circuit 200 supports. The greater the count of amplification circuits in series, the greater the amount of current that the power amplification circuit 200 supports.

It should be noted that the power amplification circuit 200 in FIG. 7 is mainly used to illustrate that the plurality of amplification circuits are connected in series to form the multi-stage amplification circuit connected in in series. In some embodiments, the control circuit 100, the power amplification circuit 200, and the first voltage generation sub circuit 310 form a class A power amplifier. The control circuit 100, the power amplification circuit 200, and the second voltage generation sub circuit 320 do not have an amplifying effect, and the second voltage generation sub circuit 320 may be omitted.

Similarly, in some embodiments, the control circuit 100, the power amplification circuit 200, and the second voltage generation sub circuit 320 form a class A power amplifier. The control circuit 100, the power amplification circuit 200, and the first voltage generation sub circuit 310 do not have an amplifying effect, and the first voltage generation sub circuit 310 may be omitted.

In some embodiments, at least one amplification circuit includes a plurality of amplification circuits, and the plurality of amplification circuits may be connected in series and cascade to form a multi-stage amplification circuit. The series and cascade connection refers to the plurality of amplification circuits being connected both in series and cascade. For example, the power amplification circuit 200 including the plurality of amplification circuits connected in series in FIG. 7 may be connected with the power amplification circuit 200 including the plurality of amplification circuits connected in cascade in FIG. 6, thereby forming the multi-stage amplification circuit in series and cascade. The series cascade connection may also be realized in any other feasible manner to form the multi-stage amplification circuit. For example, the power amplification circuit 200 includes a plurality of groups of amplification circuits. Each group of the plurality of groups of amplification circuits includes multiple amplification circuits connected in cascade as shown in FIG. 6 and the plurality of groups of amplification circuits may be connected in series to form the multi-stage amplification circuit connected in series and cascade. As another example, the power amplification circuit 200 includes a plurality of groups of amplification circuits. Each group of the plurality of groups of amplification circuits includes multiple amplification circuits connected in series as shown in FIG. 7 and the plurality of groups of amplification circuits may be connected in cascade to form the multi-stage amplification circuit connected in series and cascade.

FIG. 8 is a schematic diagram illustrating an exemplary voltage control circuit of a grid electrode structure according to some embodiments of the present disclosure.

In some embodiments, a voltage control circuit 3000 of a grid electrode structure is configured to control the voltage of the grid electrode structure 510 within an X-ray tube. The voltage control circuit 3000 of the grid electrode structure may be similar to the voltage control circuit 2000. As shown in FIG. 8, the voltage control circuit 3000 may include a power amplification circuit 200, a voltage generation circuit 300, and a control circuit 100. An output port of the voltage control circuit 3000 of the grid electrode structure (e.g., the voltage output port 203 of the power amplification circuit 200) is connected to the grid electrode structure 510 within the X-ray tube for providing a target voltage to the grid electrode structure. More descriptions regarding the power amplification circuit 200, the voltage generation circuit 300, and the control circuit 100 may be found elsewhere in the present disclosure (e.g., FIGS. 2-7 and the related description).

The grid electrode structure refers to an element used to control the electrical conductivity of an electronic device (e.g., the MOSFET). The grid electrode structure 510 controls the electrical conductivity of the electronic device by changing the voltage between a grid electrode and a source electrode.

The grid electrode is a mesh-type electrode or a spiral-type electrode consisting of thin metal wires located at a specific location in the electronic device to control the electrical conductivity of the electronic device. For example, by changing the voltage of the grid electrode, the conduction and shutdown of the X-ray tube may be controlled.

The target voltage refers to a target value (also referred to as a target voltage value) of the output voltage of the power amplification circuit 200. The target voltage value may be within a preset output range. The target voltage is continuously and arbitrarily adjustable in the preset output range.

The preset output range refers to a preset range of variation of the output voltage of the power amplification circuit 200. For example, the preset output range is within a range of
10 kV~10 kV, −50 kV~50 kV, etc.

In some embodiments, the preset output range is determined based on actual needs. For example, the preset output range is determined based on a plurality of rated input voltages of a load, such that the preset output range covers the plurality of rated input voltages of the load.

In some embodiments, the voltage value of the voltage generation circuit 300 may be the maximum or minimum value in the preset output range. For example, the preset output range is within a range of −10 kV~10 kV, and the voltage value of the voltage generation circuit 300 may be 10 kV or 10 kV.

In some embodiments, the voltage control circuit 3000 of the grid electrode structure is integrated within the X-ray tube, i.e., the power amplification circuit 200, the voltage generation circuit 300, and the control circuit 100 are integrated within the X-ray tube.

In some embodiments of the present disclosure, by integrating the voltage control circuit of the grid electrode structure within the X-ray tube, not only space may be saved, but also the voltage control signal generated by the voltage control circuit of the grid electrode structure may be avoided to affected by a parasitic capacitance of a high-voltage cable during transmission, thereby reducing the delay of the voltage control signal and suppressing waveform distortion.

In some embodiments, the voltage control circuit of the grid electrode structure is connected to the X-ray tube and a distance between the voltage control circuit of the grid electrode structure and the X-ray tube is as short as possible. That is, the power amplification circuit 200, the voltage generation circuit 300, and the control circuit 100 of the voltage control circuit 3000 of the grid electrode structure are located outside of the X-ray tube. However, it is necessary to try to ensure that the distance between the voltage control circuit of the grid electrode structure and the X-ray tube is as short as possible.

The X-ray tube generates a high temperature when it operates, and in some embodiments of the present disclosure, making the voltage control circuit independent of the X-ray tube prevents the voltage control circuit from being exposed to thermal radiation, reducing the effect of thermal stress on the circuit components, and extending the service life of the voltage control circuit. When the distance between the voltage control circuit of the grid electrode structure and the X-ray tube is large, the quality of the signal transmission is poor, and the control signal is susceptible to interference or distortion. By controlling the distance between the voltage control circuit of the grid electrode structure and the X-ray tube to be as short as possible, the stability of the connection between the voltage control circuit of the grid electrode structure and the X-ray tube, as well as the transmission of the signal, may be ensured.

In some embodiments, the voltage control circuit of the grid electrode structure is integrated within a high voltage generator and connected with the X-ray tube. More descriptions regarding the high voltage generator may be found in FIG. 19 and related descriptions.

In some embodiments of the present disclosure, by integrating the voltage control circuit of the grid electrode structure within the high voltage generator, external components and wiring between the voltage control circuit of the grid electrode structure and the high voltage generator may be reduced, simplifying the system structure, improving signal transmission reliability and stability, and reducing the cost of production and maintenance.

In some embodiments, the voltage generation circuit 300 is connected with the voltage input port 202 of the power amplification circuit 200 for providing an input voltage to the power amplification circuit 200. The voltage output port 203 of the power amplification circuit 200 is connected with the grid electrode structure 510 within the X-ray tube for providing the voltage to the grid electrode structure 510. The magnitude of the voltage of the voltage generation circuit 300 is determined based on a voltage requirement range of the grid electrode structure 510 within the X-ray tube. The control circuit 100 is connected with the base control port 201 of the power amplification circuit 200. The control circuit 100 is configured to control the voltage output port 203 of the power amplification circuit 200 to output a target voltage according to the voltage control signal, and the target voltage may be within the preset output range of the grid electrode structure 510.

More descriptions regarding the target voltage and the preset output range may be found in FIGS. 2-7 and related descriptions thereof.

In some embodiments, the control circuit 100 is further configured to control the voltage of the base control port of the power amplification circuit 200 according to the voltage control signal of the grid electrode structure and control the voltage of the base control port as a preset control voltage after the output voltage of the voltage output port reaches the target voltage.

In conjunction with the above, the voltage control signal refers to a signal for controlling a value of the output voltage of the voltage output port 203 as a value of the target voltage. Correspondingly, the voltage control signal of the grid electrode structure refers to a signal for controlling a value of the output voltage of the voltage output port 203 as a value of the target voltage. The value of the target voltage is the target voltage required by the grid electrode structure (e.g., any value within a range of −10 kV~10 kV or −50 kV~50 kV). In some embodiments, the target voltage is arbitrarily and continuously variable in the preset output range. That is to say, based on the actual voltage demand of the grid electrode structure 510 (e.g., a voltage value to be changed), the voltage control circuit of the grid electrode structure 3000 may generate the voltage control signal such that the control circuit 100 controls the voltage output port 203 of the power amplification circuit 200 to output the target voltage matching the actual voltage demand based on the voltage control signal. More descriptions regarding the control signal may be found in FIG. 2 and related descriptions thereof.

In some embodiments, when the target voltage of the grid electrode structure is a fixed value, the control circuit 100 controls the voltage at the base control port 201 to be the preset control voltage after the voltage of the voltage output port 203 reaches the target voltage of the grid electrode structure. When the target voltage of the grid electrode structure continuously changes, the control circuit 100 may control the voltage of the base electrode control port 201 to cause the output voltage of the power amplification circuit 200 to follow the continuously varying target voltage of the grid electrode structure, for example, 10 kV at 0.1 seconds, switching to 20 kV at 0.2 seconds, switching to 30 kV at 0.3 seconds, or the like. Specifically, the control circuit 100 realizes that the output voltage follows the continuously varying target voltage of the grid electrode structure based on the output voltage and the target voltage of the grid electrode structure through negative feedback adjustment.

In some embodiments, the preset control voltage is a control voltage of a base control port for maintaining the target voltage.

The control voltage of the base control port for maintaining the target voltage is a voltage applied to the base control port. The control voltage of the base control port is configured to adjust and control the base current, thus controlling the operating state and output current of the entire power amplification circuit 200.

Some parasitic capacitances may be included in the grid electrode structure 510 connected with the voltage output port 203 of the power amplification circuit 200, thereby creating a leakage current in the voltage output port 203 of the power amplification circuit 200. In some embodiments, in order to maintain the voltage of the voltage output port 203 matching the target voltage of the grid electrode structure, the control voltage applied to the base control port 201 of the power amplification circuit 200 may be determined based on a parameter (e.g., impedance, capacitance resistance, etc.) and an operating state (e.g., conduction or shutdown) of the circuit structure or component connected with the voltage output port 203 of the power amplification circuit 200, so that the charging current of the voltage output port 203 of the power amplification circuit 200 is offset from its leakage current, and the voltage of the voltage output port 203 of the power amplification circuit 200 is maintained stable.

In some embodiments of the present disclosure, fast switching of any electrical level within the grid voltage control range may be realized by controlling the voltage of the base control port of the power amplification circuit. Precise control of the voltage of the grid electrode structure within the X-ray tube is realized, improving the operating stability of the X-ray device.

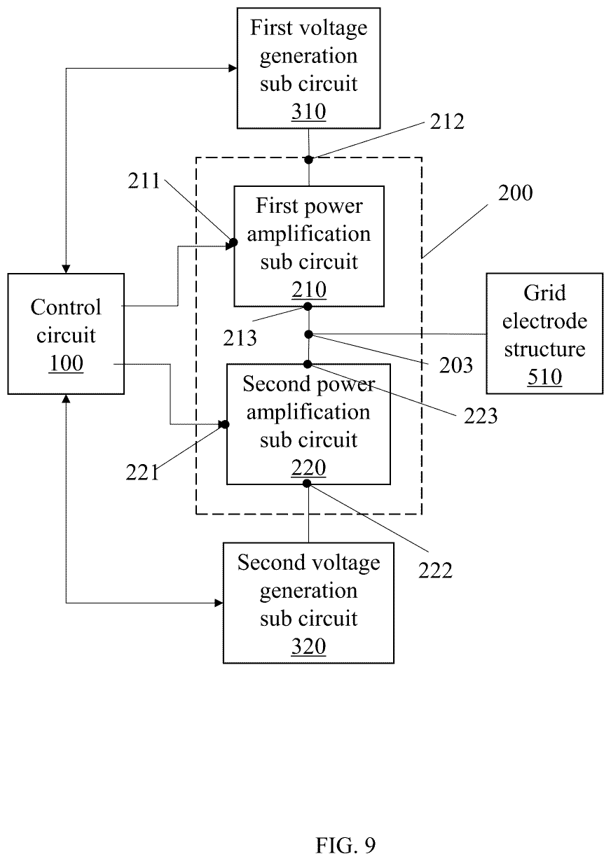

FIG. 9 is a schematic diagram illustrating an exemplary voltage control circuit of a grid electrode structure according to some other embodiments of the present disclosure.

The voltage control circuit of the grid electrode structure shown in FIG. 9 is similar to the voltage control circuit shown in FIG. 3, with the difference that the voltage output port 203 in FIG. 9 is connected to the grid electrode structure 510. More detailed descriptions may be found in FIG. 3 and related descriptions thereof.

In some embodiments, as shown in FIG. 9, the voltage generation circuit 300 of the voltage control circuit of the grid electrode structure includes a first voltage generation sub circuit 310 and a second voltage generation sub circuit 320. More descriptions regarding the first voltage generation sub circuit 310 and the second voltage generation sub circuit 320 may be found in FIG. 3 and related descriptions thereof.

In some embodiments, as shown in FIG. 9, the power amplification circuit 200 includes a first power amplification sub circuit 210 and a second power amplification sub circuit 220. More descriptions regarding the power amplification circuit 200, the first power amplification sub circuit 210, and the second power amplification sub circuit 220 may be found in FIG. 3 and related descriptions thereof.

In some embodiments, the control circuit 100 is also configured to adjust the output voltage of the voltage generation circuit 300 to control the input voltage of the power amplification circuit 200.

As shown in FIG. 9, the control circuit 100 is connected with the first voltage generation sub circuit 310 to control the input voltage of the first power amplification sub circuit 210. The control circuit 100 is connected with the second voltage generation sub circuit 320 to control the input voltage of the second power amplification sub circuit 220.

Some embodiments of the present disclosure, by controlling the input voltage of the power amplification circuit 200 through the control circuit, the output voltage range of the power amplification circuit may be changed, and the adjustable output voltage range may support the use of loads or circuits with different rated voltages, which has wider application range.

In some embodiments, the control circuit 100 is also configured to provide a bias voltage signal to the first base control port and the second base control port. More descriptions regarding the bias voltage signal may be found in FIG. 4 and related descriptions thereof.

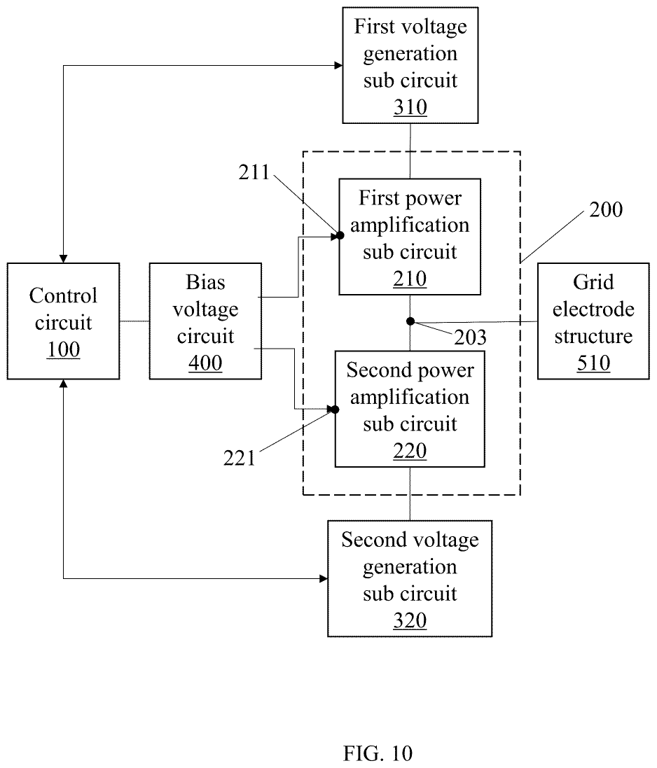

FIG. 10 is a schematic diagram illustrating an exemplary voltage control circuit of a grid electrode structure according to some other embodiments of the present disclosure.

The voltage control circuit of the grid electrode structure shown in FIG. 10 is similar to the voltage control circuit shown in FIG. 4, with the difference that the voltage output port 203 in FIG. 10 is connected with the grid electrode structure 510. More descriptions may be found in FIG. 4 and related descriptions thereof.

In some embodiments, as shown in FIG. 10, a bias voltage circuit 400 is provided between the power amplification circuit 200 and the control circuit 100. More descriptions regarding the bias voltage circuit 400 may be found in FIG. 4 and related descriptions thereof.

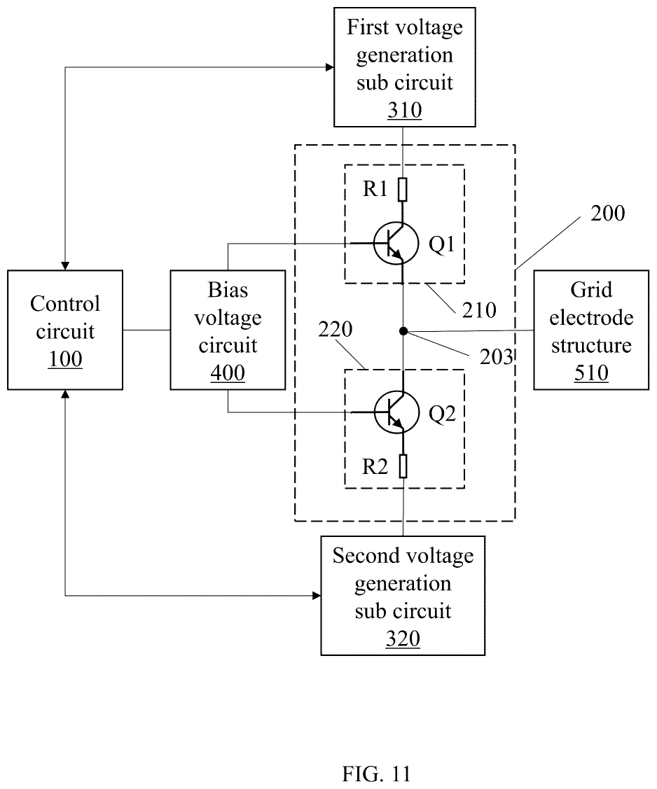

FIG. 11 is a schematic diagram illustrating an exemplary voltage control circuit according to some embodiments of the present disclosure.

The voltage control circuit of the grid electrode structure shown in FIG. 11 is similar to the voltage control circuit shown in FIG. 5, with the difference that the voltage output port 203 in FIG. 11 is connected with the grid electrode structure 510. More descriptions may be found in FIG. 5 and related descriptions thereof.

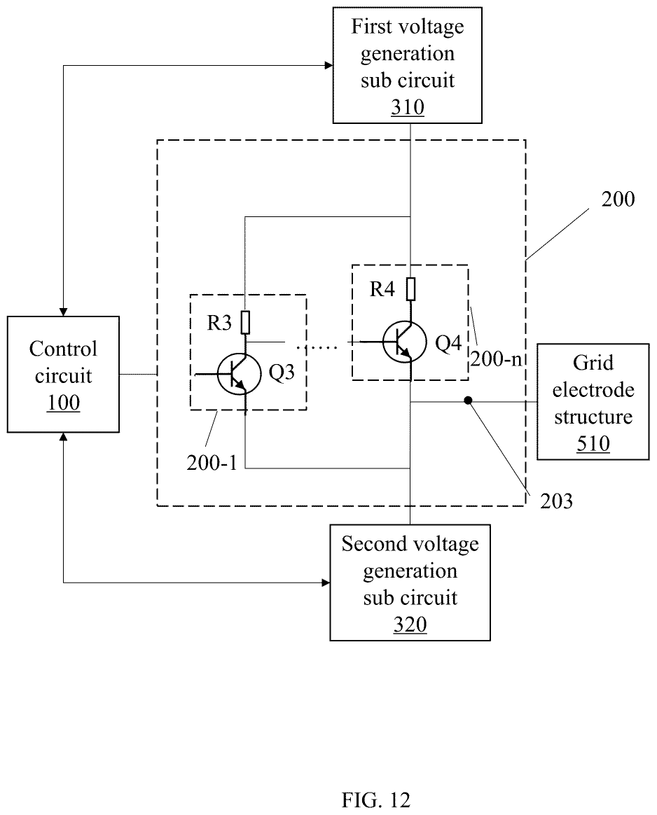

FIG. 12 is a schematic diagram illustrating an exemplary voltage control circuit according to some other embodiments of the present disclosure.

In some embodiments, as shown in FIG. 12, the voltage control circuit includes a power amplification circuit 200, a voltage generation circuit 300, and a control circuit 100. The power amplification circuit 200 includes a plurality of amplification circuits, and the plurality of amplification circuits form a multi-stage amplification circuit by connecting a voltage input port of one amplification circuit to a base control port of another amplification circuit. The base control port of the first amplification circuit 200-1 in the multi-stage amplification circuit is connected with the control circuit 100, and the voltage output port of the last amplification circuit 200-n is set as the voltage output port 203 of the power amplification circuit 200.

In some embodiments, as shown in FIG. 12, the plurality of amplification circuits are connected in cascade to form the multi-stage amplification circuit.

The plurality of amplification circuits connected in cascade shown in FIG. 12 is similar to that of FIG. 6, with the difference that the voltage output port 203 in FIG. 12 is connected with the grid electrode structure 510. More descriptions regarding the plurality of amplification circuits connected in cascade may be found in FIG. 6 and related descriptions thereof.

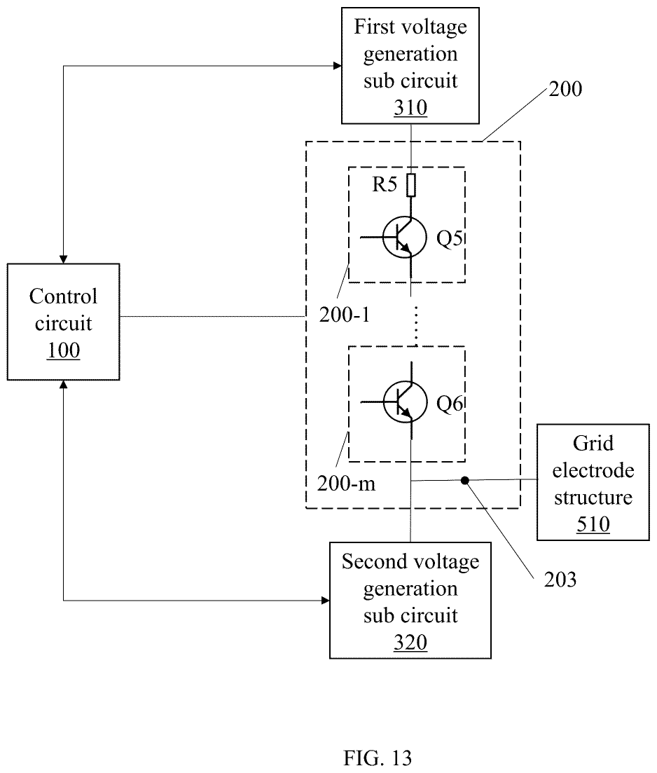

FIG. 13 is a schematic diagram illustrating an exemplary voltage control circuit according to some other embodiments of the present disclosure.

In some embodiments, as shown in FIG. 13, the voltage control circuit includes a power amplification circuit 200, a voltage generation circuit 300, and a control circuit 100. The power amplification circuit 200 includes a plurality of amplification circuits. The plurality of amplification circuits form a multi-stage amplification circuit by connecting a voltage output port of one amplification circuit to a voltage input port of another amplification circuit.

In some embodiments, the multi-stage amplification circuit is formed by connecting the plurality of amplification circuits in series.

In some embodiments, base control ports of the plurality of amplification circuits are connected to the control circuit. The voltage input port of the first amplification circuit 200-1 of the plurality of amplification circuits is connected with the voltage generation circuit, and the voltage output port of the last amplification circuit 200-m is set as the voltage output port 203 of the power amplification circuit 200.

The plurality of amplification circuits connected in series shown in FIG. 13 are similar to that in FIG. 7, with the difference that the voltage output port 203 in FIG. 13 is connected with the grid electrode structure 510. More descriptions regarding the plurality of amplification circuits connected in series may be found in FIG. 7 and related descriptions thereof.

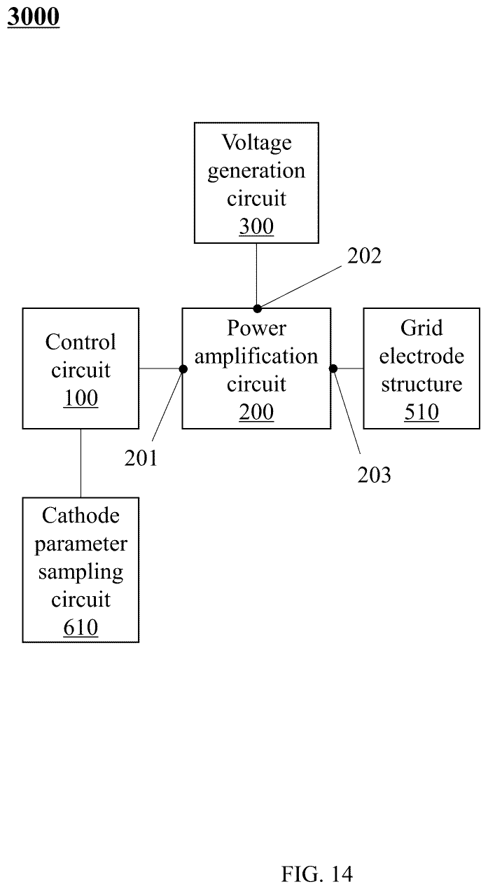

FIG. 14 is a schematic diagram illustrating an exemplary voltage control circuit of a grid electrode structure according to some other embodiments of the present disclosure. The voltage control circuit 3000 of the grid electrode structure as shown in FIG. 14 may be similar to the voltage control circuit 3000 as shown in FIG. 8. For example, the voltage control circuit 3000 may include a power amplification circuit 200, a voltage generation circuit 300, and a control circuit 100.

In some embodiments, as shown in FIG. 14, the voltage control circuit 3000 of the grid electrode structure further includes a cathode parameter sampling circuit 610.

The cathode parameter sampling circuit 610 is configured to measure an operating parameter of a cathode in an X-ray tube. The cathode is the portion of the X-ray tube that emits electrons.

In some embodiments, one end of the cathode parameter sampling circuit 610 is connected with the cathode of the X-ray tube, and the cathode parameter sampling circuit 610 samples the operating parameter of the cathode within the X-ray tube. The other end of the cathode parameter sampling circuit 610 is connected with the control circuit 100, and the control circuit 100 adjusts the voltage of the base electrode control port 201 according to the operating parameter to control the target voltage of the grid electrode structure to adapt the operating parameter of the cathode in the X-ray tube.

The cathode within the X-ray tube may be used as a reference for sampling the operating parameter of the cathode within the X-ray tube by the cathode parameter sampling circuit 610, to obtain, in the rising phase and the falling phase of the high voltage generator 710, the operating parameter of the cathode within the X-ray tube. Adjusting the target voltage of the grid electrode structure based on the operating parameter allows the target voltage of the grid electrode structure to adapt the operating parameter of the cathode within the X-ray tube. Using the radiation doses in the rising phase and falling phase of the high voltage generator 710 for CT sampling prevents the patient from absorbing an invalid dose. The high voltage generator 710 may be configured to power the voltage control circuit of the grid electrode structure, and more descriptions for the high voltage generator 710 may be found in FIG. 19.

In some embodiments, the control circuit 100 determines the target voltage of the grid electrode structure by querying a first preset table based on the operating parameter. The first preset table includes a correspondence relationship between the operating parameter and the target voltage of the grid electrode structure. The first preset table may be constructed experimentally or by theoretical calculation. The operating parameter includes, but is not limited to, at least one of a cathode voltage, a tube current, a filament current, or the like.

In some embodiments, the cathode parameter sampling circuit 610 includes at least one of a cathode voltage sampling circuit, a tube current sampling circuit, a filament current sampling circuit, or the like.

In some embodiments, the cathode voltage sampling circuit is configured to sample the voltage of the cathode within the X-ray tube, and the control circuit 100 adjusts the voltage of the base control port 201 according to the voltage of the cathode within the X-ray tube to control the target voltage of the grid electrode structure to adapt the operating parameter of the cathode within the X-ray tube. The voltage of the cathode within the X-ray tube is a key parameter for controlling electron emission and acceleration. The greater the voltage of the cathode, the greater the velocity of the electrons emitted from the cathode.

In some embodiments, the tube current sampling circuit is configured to sample the current flowing through the cathode within the X-ray tube, and the control circuit 100 adjusts the voltage of the base control port according to the current flowing through the cathode within the X-ray tube to control the target voltage of the grid electrode structure to adapt the operating parameter of the cathode within the X-ray tube. The current flowing through the cathode within the X-ray tube reflects the strength of the electron beam impinging on the anode and the generation efficiency of the X-ray. The higher the tube current, the greater the strength of the electron beam impinging on the anode, and the more efficiently the X-ray is generated.

In some embodiments, the cathode of the X-ray tube is heated by a filament to produce electrons, thus ensuring that the cathode is operated at a proper temperature to emit electrons stably.

In some embodiments, the filament current sampling circuit is configured to sample the current of the heated filament within the X-ray tube, and the control circuit 100 adjusts the voltage of the base electrode control port based on the current for heating the filament within the X-ray tube to control the target voltage of the grid electrode structure to adapt the operating parameter of the cathode within the X-ray tube.

In some embodiments of the present disclosure, the operating parameter of the cathode is collected by the cathode parameter sampling circuit to adjust the voltage of the base control port, which may improve the precision of controlling the voltage within the X-ray tube.

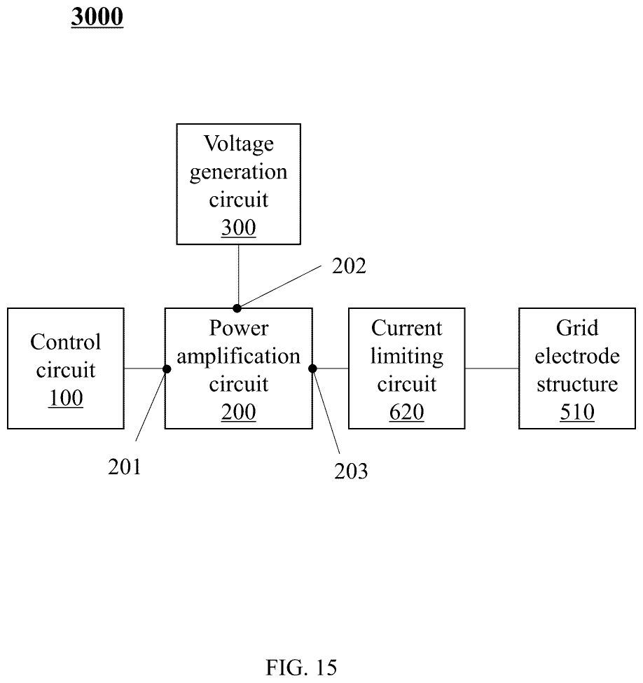

FIG. 15 is a schematic diagram illustrating an exemplary voltage control circuit of a grid electrode structure according to some other embodiments of the present disclosure. The voltage control circuit 3000 of the grid electrode structure as shown in FIG. 15 may be similar to the voltage control circuit 3000 as shown in FIG. 8. For example, the voltage control circuit 3000 may include a power amplification circuit 200, a voltage generation circuit 300, and a control circuit 100. As shown in FIG. 15, the voltage control circuit of the grid electrode structure 3000 also includes a current limiting circuit 620.

In some embodiments, the current limiting circuit 620 is provided between the voltage output port 203 of the power amplification circuit 200 and the grid electrode structure 510 within the X-ray tube. The current limiting circuit 620 is configured to limit a current output from the voltage output port 203.

In some embodiments, the current limiting circuit 620 may include one or more current limiting resistors. The plurality of current limiting resistors may be set in series or parallel.

As shown in FIG. 15, one end of the current limiting circuit 620 is connected with the voltage output port 203 of the power amplification circuit 200, and the other end of the current limiting circuit 620 is connected with the grid electrode structure 510.

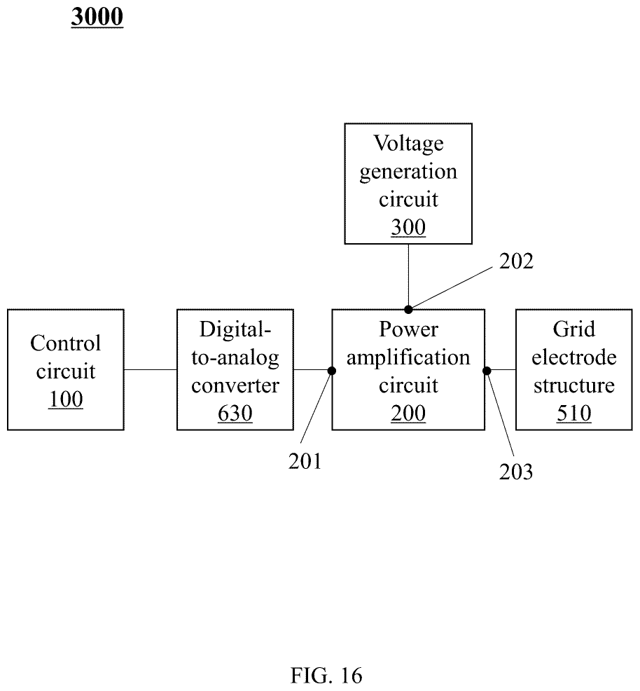

FIG. 16 is a schematic diagram illustrating an exemplary voltage control circuit of a grid electrode structure according to some other embodiments of the present disclosure. The voltage control circuit 3000 of the grid electrode structure as shown in FIG. 16 may be similar to the voltage control circuit 3000 as shown in FIG. 8. For example, the voltage control circuit 3000 may include a power amplification circuit 200, a voltage generation circuit 300, and a control circuit 100. As shown in FIG. 16, the voltage control circuit 3000 of the grid electrode structure also includes a digital-to-analog converter 630.

In some embodiments, the control circuit 100 is a digital controller. More descriptions for the control circuit 100 may be found elsewhere in the present disclosure (e.g., FIGS. 2-7).

In some embodiments, the digital-to-analog converter 630 is provided between the control circuit 100 and the power amplification circuit 200. The digital-to-analog converter 630 is configured to convert a digital control signal output from the control circuit 100 into an analog control signal that is output to the base control port 201.

In some embodiments, the control circuit 100 includes an analog controller, and the analog controller may provide a control voltage to the base control port 201 of the power amplification circuit 200 to control the operating state of the power amplification circuit 200.

The analog controller, which corresponds to the digital controller, is configured to process the analog control signal and adjust and control the output of the digital-to-analog converter 630 in response to the change in the analog control signal.

In some embodiments of the present disclosure, the digital control signal output from the digital controller is converted to the analog control signal by the digital-to-analog converter, or the analog control signal is directly output from the analog controller, which may improve the accuracy of the control signal.

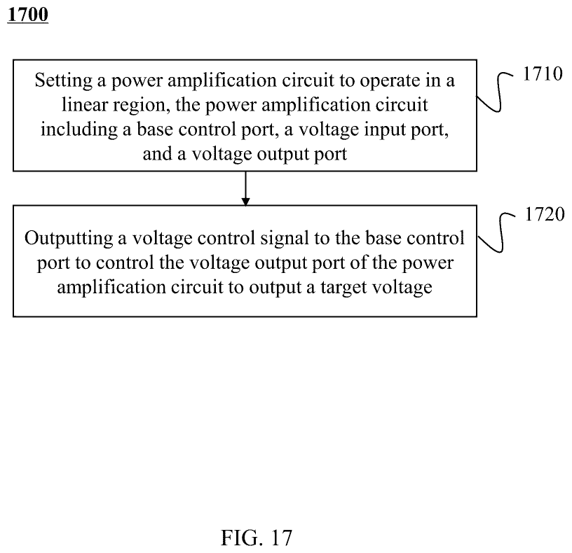

FIG. 17 is a flowchart illustrating an exemplary multi-voltage output process according to some embodiments of the present disclosure.

As shown in FIG. 17, process 1700 includes the following operations. In some embodiments, process 1700 is performed by the control circuit 100.

In 1710, the power amplification circuit is set to operate in a linear region, and the power amplification circuit includes a base control port, a voltage input port, and a voltage output port.

In some embodiments, the control circuit 100 generates a bias voltage signal to cause the power amplification circuit 200 to operate in the linear region. More descriptions regarding the linear region may be found in FIG. 2 and related descriptions thereof. More descriptions regarding the bias voltage signal may be found in FIG. 4 and related descriptions thereof.

In some embodiments, the control circuit 100 generates the bias voltage signal via the bias voltage circuit 400 to cause the power amplification circuit 200 to operate in the linear region.

In 1720, a voltage control signal is output to the base control port to control the voltage output port of the power amplification circuit to output a target voltage.

The target voltage is able to be changed to any value within a preset output range. More descriptions regarding the target voltage and the preset output range may be found in FIG. 2 and related descriptions thereof.

In some embodiments, the control circuit 100 generates the voltage control signal to contr the magnification times or enlargement factor of the power amplification circuit 200, thereby controlling the output voltage of the voltage output port 203 of the power amplification circuit 200.

In some embodiments, the amplification of the power amplification circuit 200 is negatively correlated with the frequency of the voltage control signal. The control circuit 100 adjusts the output voltage of the voltage output port 203 of the power amplification circuit 200 to the target voltage based on the output voltage of the voltage output port 203 through negative feedback adjustment.

In some embodiments of the present disclosure, the output voltage of the voltage output port 203 of the power amplification circuit 200 is controlled by the voltage control signal, so that the output voltage of the voltage output port 203 of the power amplification circuit 200 may be stabilized at the target voltage.

In some embodiments, the process 1700 further includes controlling the voltage of the base control port of the power amplification circuit to be a preset control voltage after the output voltage of the voltage output port reaches the target voltage.

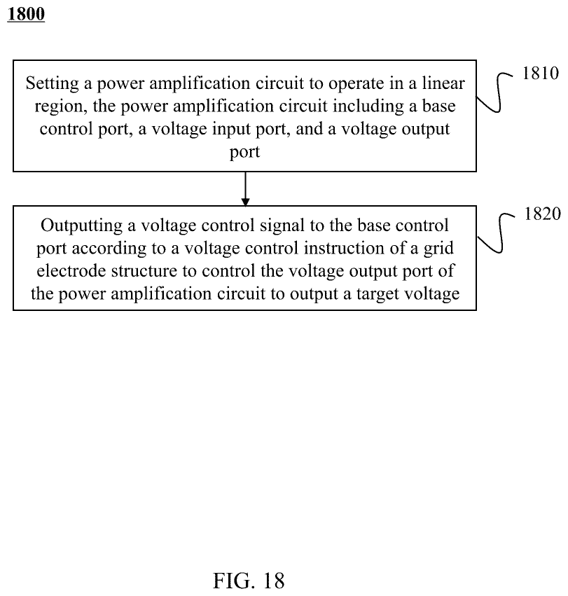

FIG. 18 is a flowchart illustrating an exemplary process for controlling the voltage of a grid electrode structure according to some embodiments of the present disclosure. In some embodiments of the present disclosure, a method for controlling a voltage of a grid electrode structure is used to control a voltage of a grid electrode structure within an X-ray tube.

As shown in FIG. 18, the process 1800 includes the following operations. In some embodiments, process 1800 is performed by the control circuit 100.

In 1810, a power amplification circuit is set to operate in a linear region, and the power amplification circuit includes a base control port, a voltage input port, and a voltage output port.

More descriptions regarding setting the power amplification circuit to operate in the linear region may be found elsewhere in the present disclosure (e.g., FIG. 17 and related descriptions thereof).

In 1820, a voltage control signal is output to the base control port of the power amplification circuit according to a voltage control instruction of the grid electrode structure to control the voltage output port of the power amplification circuit to output a target voltage.

In some embodiments, the control circuit 100 outputs the voltage control signal of a specified frequency based on the voltage control instruction of the grid electrode structure to control the voltage output port 203 of the power amplification circuit 200 to output the target voltage.

In some embodiments, the power amplification circuit 200 includes a base control port 201, a voltage input port 202, and a voltage output port 203. The target voltage of the grid electrode structure is able to be changed to any value within a preset output range, and the preset output range may be determined by the voltage generation circuit 300 connected with the voltage input port 201. The voltage output port 203 of the voltage control circuit 3000 of the grid electrode structure is connected to the grid electrode structure 510 within the X-ray tube. The power amplification circuit 200 includes at least one semiconductor device, which includes but is not limited to, a base-controllable semiconductor device such as a transistor, a MOSFET, an IGBT, or the like. By setting the semiconductor device to operate in the linear region, the power amplification circuit 200 is set to operate in the linear region. At this time, the voltage of the voltage output port 203 of the power amplification circuit 200 varies linearly and continuously. By the voltage generation circuit 300, the preset output range of the voltage that may be output by the voltage control circuit 3000 of the grid electrode structure may be determined. By controlling the voltage of the base control port 201 of the power amplification circuit 200, the voltage of the voltage output port 203 of the power amplification circuit 200 may be controlled to output any value within the preset output range, realizing continuous adjustment of the output voltage of the voltage control circuit, without the need to set a plurality of switches for adjusting the output voltage of the voltage control circuit, to achieve arbitrary voltage switching within the preset output range, which greatly expands the application scenario of the voltage control circuit 3000 of the grid electrode structure.

More descriptions regarding the target voltage and preset output range may be found in FIG. 2 and related descriptions thereof.

In some embodiments, the method for controlling the voltage of the grid electrode structure further includes sampling an operating parameter of the cathode within the X-ray tube; and regulating the voltage of the base control port according to the operating parameter.

In some embodiments, the operating parameter of the cathode within the X-ray tube may include a voltage of the cathode within the X-ray tube and a current of the cathode within the X-ray tube.

For example, the control circuit 100 obtains a cathode voltage sampling signal by sampling the voltage of the cathode within the X-ray tube in real time, adjusts the voltage control signal of the grid electrode structure according to the cathode voltage sampling signal, and then adjusts the voltage of the base control port according to the voltage control instruction of the grid electrode structure, to control the target voltage of the grid electrode structure to adapt the voltage of the cathode in the X-ray tube.

In some embodiments, the voltage of the cathode within the X-ray tube may be sampled to obtain the cathode voltage sampling signal, and the control circuit 100 adjusts the voltage of the base control port according to the voltage of the cathode within the X-ray tube to control the target voltage of the grid electrode structure to adapt the voltage of the cathode within the X-ray tube.

In some embodiments, the control circuit 100 may sample the current flowing through the cathode within the X-ray tube and adjust the voltage of the base control port based on the current flowing through the cathode within the X-ray tube to control the target voltage of the grid electrode structure to adapt the current of the cathode within the X-ray tube.

In some embodiments, the method for controlling the voltage of the grid electrode structure further includes controlling the voltage of the base control port based on a cathode operating parameter within the X-ray tube to adjust the voltage of the voltage output port.

In some embodiments, the cathode operating parameter within the X-ray tube may be obtained by sampling or may be predicted based on an operating model of the X-ray tube. By predicting the cathode operating parameter within the X-ray tube to control the voltage of the base control port in advance, the voltage of the grid electrode structure 510 connected with the voltage output port 203 may be made to reach the target voltage of the grid electrode structure in a shorter time, reducing the delay in the voltage switching process, maximizing the utilization of the radiation dose discharged within the X-ray tube, and reducing the absorbed radiation dose of the patient during a single imaging process.

FIG. 19 is a schematic diagram illustrating an exemplary imaging device according to some embodiments of the present disclosure.

In some embodiments, the imaging device includes an X-ray tube and a voltage control circuit of the grid electrode structure.

The X-ray tube is a component that produces X-rays.

The voltage control circuit of the grid electrode structure is connected with the grid electrode structure 510 within the X-ray tube. More descriptions regarding the voltage control circuit of the grid electrode structure may be found elsewhere in the present disclosure (e.g., FIGS. 1-16 and the descriptions thereof).

In some embodiments, as shown in FIG. 19, the imaging device further includes a high voltage generator 710.

The high voltage generator 710 is configured to provide a high voltage power supply. In some embodiments, the high voltage generator 710 may act as a Grid Control power supply to provide power to the voltage control circuit of the grid electrode structure.

In some embodiments, the Grid Control power supply may provide power for the voltage control circuit of the grid electrode structure. For example, the Grid Control power supply may provide power for the control circuit 100, the first voltage generation sub circuit 310, the first power amplification sub circuit 210, the second voltage generation sub circuit 320, and the second power amplification sub circuit 220.

In some embodiments, fiber optics are used for communication between the high voltage generator 710 and the control circuit 100. The control circuit 100 may automatically control the output voltage of the high voltage generator 710.

In some embodiments, the high voltage generator 710 may communicate directly with the X-ray apparatus. The staff may manually control the output voltage of the high voltage generator 710 through the imaging device.

In some embodiments, the imaging device may also power the voltage control circuit of the grid electrode structure via an external power supply instead of the high voltage generator 710 as the Grid Control power supply.

In some embodiments, the first voltage generation sub circuit 310 and the second voltage generation sub circuit 320 may be provided outside the X-ray tube. An input voltage of the first voltage generation sub circuit 310 and an input voltage of the second voltage generation sub circuit 320 are transmitted to the Grid Control power supply via a high voltage cable to be output to the first power amplification sub circuit 210 and the second power amplification sub circuit 220, respectively.

In some embodiments, if the length of the high voltage cable between the high voltage generator 710 and the X-ray tube is less than a preset length threshold, and on the premise that the switching speed of the output voltage of the Grid Control power supply and the output power of a grid power supply satisfies the requirements of the imaging device, the entire Grid Control power supply and the control circuit 100 may also be provided outside the X-ray tube. The preset length threshold is the maximum value of the length of the high voltage cable that does not interfere with the signal transmission, which may be preset. The requirements of the imaging device may be that the switching speed of the output voltage of the Grid Control power supply reaches a preset switching speed threshold, and the output power of the grid power supply is greater than a preset power. The preset switching speed threshold and the preset power may be determined based on the operating parameter of the imaging device.

In some specific application embodiments, an input voltage is provided to the power amplification circuit by a voltage generation circuit based on the preset output range of the voltage control circuit. By setting the power amplification circuit to operate in the linear region, outputting the voltage control signal by the control circuit to the base control port of the power amplification circuit, and controlling the voltage output port of the power amplification circuit to output an arbitrary voltage within the preset output range as the target voltage, a continuous variety of voltages are output based on the same hardware structure, solving the problem that the current voltage control structure can only switch between a limited count of electrical levels. On the other hand, it is also possible to track the operating parameter of the cathode of the X-ray tube as a control instruction, which also ensures that the focus of the tube current of the X-ray tube meets the imaging requirements at the changing stage of the operating parameter of the cathode of the X-ray tube, thereby improving the dose utilization of the X-ray and reduce the ineffective dose of radiation to which the patient is exposed.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements, and amendments to the present disclosure. These alterations, improvements, and amendments are intended to be suggested by this disclosure and are within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure, or feature described in connection with the embodiment is included in at least one embodiment of the present disclosure. Therefore, it is emphasized and should be appreciated that two or more references to “an embodiment”, “one embodiment”, or “an alternative embodiment” in various portions of the present disclosure are not necessarily all referring to the same embodiment. In addition, some features, structures, or characteristics of one or more embodiments in the present disclosure may be properly combined.

Furthermore, the recited order of processing elements or sequences, or the use of numbers, letters, or other designations, therefore, is not intended to limit the claimed processes and methods to any order except as may be specified in the claims. Although the above disclosure discusses some embodiments of the invention currently considered useful by various examples, it should be understood that such details are for illustrative purposes only, and the additional claims are not limited to the disclosed embodiments. Instead, the claims are intended to cover all combinations of corrections and equivalents consistent with the substance and scope of the embodiments of the present disclosure. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that object of the present disclosure requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about”, “approximate”, or “substantially”. For example, “about”, “approximate”, or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes. History application documents that are inconsistent or conflictive with the contents of the present disclosure are excluded, as well as documents (currently or subsequently appended to the present specification) limiting the broadest scope of the claims of the present disclosure. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described. Please amend the claims as indicated below. This listing of claims will replace all prior versions and listings of claims in the application:

1. A voltage control circuit of a grid electrode structure for controlling a voltage of the grid electrode structure within an X-ray tube, comprising:
a power amplification circuit including a base control port, a voltage input port, and a voltage output port, wherein the voltage output port is connected with the grid electrode structure of the X-ray tube for providing a target voltage to the grid electrode structure;
a voltage generation circuit connected with the voltage input port of the power amplification circuit for providing an input voltage to the power amplification circuit; and
a control circuit connected with the base control port of the power amplification circuit for controlling, according to a voltage control signal, the voltage output port of the power amplification circuit to output the target voltage, wherein the target voltage is able to be changed to be any value within a preset output range.

2. The voltage control circuit of claim 1, wherein a voltage value of the voltage generation circuit is determined according to a voltage requirement range of the grid electrode structure of the X-ray tube.

3. The voltage control circuit of claim 1[[or 2]], wherein the power amplification circuit operates in a linear region.

4. The voltage control circuit of claim wherein the voltage generation circuit includes a first voltage generation sub circuit and a second voltage generation sub circuit, the first voltage generation sub circuit is configured to provide a positive voltage to the power amplification circuit, and the second voltage generation sub circuit is configured to provide a negative voltage to the power amplification circuit.

5. The voltage control circuit of claim 1, wherein the power amplification circuit includes at least one amplification circuit; and
a base control port of the at least one amplification circuit is connected with the control circuit, a voltage input port of the at least one amplification circuit is connected with the voltage generation circuit, and a voltage output port of the at least one amplification circuit is set as the voltage output port of the power amplification circuit.

6. The voltage control circuit of claim 5, wherein the at least one amplification circuit includes a plurality of amplification circuits, and the plurality of amplification circuits form a multi-stage amplification circuit by connecting a voltage input port of one of the plurality of amplification circuits to a base control port of another amplification circuit of the plurality of amplification circuits; and
a base control port of a first amplification circuit of the multi-stage amplification circuit is connected with the control circuit, and a voltage output port of a last amplification circuit is set to be the voltage output port of the power amplification circuit.

7. The voltage control circuit of claim 5, wherein the at least one amplification circuit includes a plurality of amplification circuits, and the plurality of amplification circuits form a multi-stage amplification circuit by connecting a voltage output port of one of the plurality of amplification circuits to a voltage input port of another amplification circuit of the plurality of amplification circuits; and
a base control port of the plurality of amplification circuits are connected with the control circuit, a voltage input port of a first amplification circuit of the multi-stage amplification circuit is connected with the voltage generation circuit, and a voltage output port of a last amplification circuit is set to be the voltage output port of the power amplification circuit.

8. The voltage control circuit of claim 4, wherein the power amplification circuit includes a first power amplification sub circuit and a second power amplification sub circuit, wherein:
a first base control port of the first power amplification sub circuit and a second base control port of the second power amplification sub circuit are connected with the control circuit;
a first voltage input port of the first power amplification sub circuit is connected with the first voltage generation sub circuit, and a second voltage input port of the second power amplification sub circuit is connected with the second voltage generation sub circuit; and
the first voltage output port of the first power amplification sub circuit is connected with the second voltage output port of the second power amplification sub circuit to form the voltage output port of the power amplification circuit.

9. The voltage control circuit of claim 8, wherein:
the control circuit is further configured to provide a bias voltage signal to the first base control port and the second base control port; or
a bias voltage circuit is provided between the power amplification circuit and the control circuit, and the first base control port of the first power amplification sub circuit and the second base control port of the second power amplification sub circuit are connected with the control circuit via the bias voltage circuit.

10. The voltage control circuit of claim wherein the control circuit is further configured to control a voltage of the base control port according to a voltage control instruction of the grid electrode structure, and control the voltage of the base control port as a preset control voltage after an output voltage of the voltage output port reaches the target voltage.

11. The voltage control circuit of claim 10, wherein the preset control voltage is a base port control voltage for maintaining the target voltage.

12. The voltage control circuit of claim 1, further comprising a cathode parameter sampling circuit for sampling an operating parameter of a cathode within the X-ray tube, wherein:
the control circuit is further connected with the cathode parameter sampling circuit for adjusting a voltage of the base control port according to the operating parameter.

13. The voltage control circuit of claim 12, wherein the cathode parameter sampling circuit includes at least one of a cathode voltage sampling circuit, a tube current sampling circuit, or a filament current sampling circuit.

14. The voltage control circuit of claim 1, further comprising:
a current limiting circuit provided between the voltage output port and the grid electrode structure within the X-ray tube for limiting a current output from the voltage output port.

15. The voltage control circuit of claim wherein the control circuit includes a digital controller; and
a digital-to-analog converter is provided between the control circuit and the power amplification circuit, and the digital-to-analog converter is configured to convert a digital control signal output from the control circuit into an analog control signal to be output to the base control port.

16. The voltage control circuit of claim wherein the control circuit is further configured to adjust an output voltage of the voltage generation circuit to control the input voltage of the power amplification circuit.

17. The voltage control circuit of claim 1, wherein the voltage control circuit of the grid electrode structure is integrated within the X-ray tube.

18. A method for controlling a voltage of a grid electrode structure within an X-ray tube, the method comprising:
setting a power amplification circuit to operate in a linear region, wherein the power amplification circuit includes a base control port, a voltage input port, and a voltage output port; and
outputting a voltage control signal to the base control port according to a voltage control instruction of the grid electrode structure to control the voltage output port of the power amplification circuit to output a target voltage, wherein:
the target voltage is able to be changed to any value within a preset output range, and the preset output range is determined by a voltage generation circuit connected with the voltage input port.

19. The method of claim 18, further comprising:
sampling an operating parameter of a cathode within the X-ray tube; and
adjusting a voltage of the base control port according to the operating parameter.

20. An imaging device, comprising:
an X-ray tube, and
a voltage control circuit of a grid electrode structure, wherein the voltage control circuit includes:
a power amplification circuit including a base control port, a voltage input port, and a voltage output port, wherein the voltage output port is connected with the grid electrode structure for providing a target voltage to the grid electrode structure;
a voltage generation circuit connected with the voltage input port of the power amplification circuit for providing an input voltage to the power amplification circuit; and
a control circuit connected with the base control port of the power amplification circuit for controlling, according to a voltage control signal, the voltage output port of the power amplification circuit to output the target voltage, wherein the target voltage is able to be changed to be any value within a preset output range ; and
the X-ray tube includes the grid electrode structure, a cathode, and an anode, and the voltage control circuit of the grid electrode structure is connected with the grid electrode structure within the X-ray tube.

21-23. (canceled)
